(19) United States
(12) Patent Application Publication
(10) Pub. No.: US 2008/0305027 A1
(43) Pub. Date: Dec. 11, 2008

(54) Nano-Structured Silicate, Functionalised forms Thereof, Preparation and Uses

(76) Inventors: James Howard Johnston, Wellington (NZ); Andrew James McFarlane, Waikanae (NL); Thomas Borrmann, Wellington (NL)

Correspondence Address: MERCHANT & GOULD PC, P.O. BOX 2903, MINNEAPOLIS, MN, 55402-0903, US

(21) Appl. No.: 11/814,154

(22) PCT Filed: Jan. 17, 2006
(86) PCT No.: PCT/NZ2006/000003

§ 371 Date: Apr. 8, 2008

(30) Foreign Application Priority Data
Jan. 18, 2005 (NZ) 537747

(51) Int. Cl. C01B 33/12; C01B 33/141

(52) U.S. Cl. 423/339; 428/331

(57) ABSTRACT

This invention relates to the preparation, functionalisation and use of a novel nano structured silicate, generally a calcium silicate which may be hydrated. It also relates to novel methods of producing nano structured silicates. The novel nano-structured silicate material comprises a calcium silicate in the form of platelets of about 5-10 nm thick and about 50-500 nm wide or wider stacked together in a poorly ordered framework type structure as illustrated in FIG. 1. The novel material can be prepared by reacting a calcium ion containing solution with a silicate containing solution under controlled conditions and then allowing the calcium silicate to age. The novel silicate has pores of a high volume and which are readily accessible. This provides a high oil absorption capacity and high surface area. Novel nano-structured silicate materials are produced by the invention having an oil absorption capacity up to 700 g.oil.100 g⁻¹ silicate and a surface area up to 600 m2g⁻¹. The novel material can be functionalised to yield a material having a variety of uses.

This invention relates to the preparation, functionalisation and use of a novel nano-structured silicate, generally a calcium silicate which may be hydrated. It also relates to novel methods of producing nano-structured silicates.

### BACKGROUND ART

Silicas comprising submicron particles arranged in various microstructural forms, notably essentially individual particles (fume silicas), networks (precipitated silicas or silicates) and random close packed structures (gels) are well known and are widely used in many different industry and consumer applications. These materials are well characterised and their various methods of preparation, structures, properties and applications are presented in standard texts such as Iler (1973) (Ralph K. Iler —The Chemistry of Silica, Wiley-Interscience, New York, 1979) and numerous research publications, patents and information and applications sheets by commercial suppliers. Sodium silicate (water glass) is generally used as the starting material for the preparation of precipitated silicas (and silicates) and silica gels in an aqueous system. The details of many of these preparations are proprietary to commercial manufacturers.

Precipitated silicas with a network structure have also been produced from geothermal water which contains much lower levels of dissolved silica, typically up to about 1000 mg.kg⁻¹, SiO₂ with the product being successfully tested as a filler in newsprint to reduce print-through and enhance print quality (Haiper and Johnston, 1997) (U.S. Pat. No. 5,595,717).

An aqueous solution of sodium silicate is highly alkaline with a pH typically greater than about pH=12, depending upon the dissolved silica concentration. The dominant species here are the H₃SiO₄⁻ ion and the H₂SiO₄²⁻ ion. The addition of acid reduces the pH which initiates polymerisation of these ions to produce oxygen bridged silicate polymers which can be represented simply as:

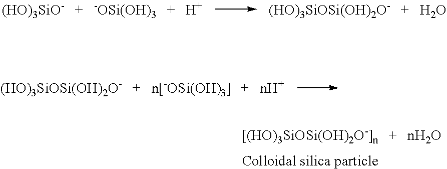

This polymerisation takes place in 3-dimensions to form nano-sized spherical silica particles which then form the requisite network or gel structures. The surfaces of the particles usually have a high density of silanol groups.

The process for precipitating silica from geothermal water which is supersaturated with dissolved silica, as described by Harper and Johnston (1997) (U.S. Pat. No. 5,595,717, 1997), involves allowing the water to age at a pH of about pH=7-9, whereupon nano-size colloidal particles of silica form according to the above mechanism. Because of the surface silanol groups these particles have a negative surface charge and will form a colloid. The addition of a metal cation, typically Ca²⁺ neutralizes this surface charge to some extent and allows these particles to come together to form a precipitated silica with a network structure. The size of the particles and hence the strength of the network structure may be reinforced by exposing the precipitate to geothermal water containing unpolymerised dissolved silica (H₃SiO₄⁻) and recovering this silica on the network structure of the original precipitated silica (Harper and Johnston, 1997) (U.S. Pat. No. 5,595,717, 1997).

### OBJECT OF THE INVENTION

The object of the invention is a novel nano-structured silicate and a process for producing such novel nano-structured silicates as well as novel methods for producing nano-structured silicates, and uses thereof.

### SUMMARY OF THE INVENTION

In accordance with the invention there is provided a nano-structured calcium silicate material which comprises nano-size platelets about 5-10 nm thick and about 50-500 nm wide stacked together in a poorly-ordered open framework type structure to provide pores which are accessible and a consequent high pore volume.

The term “comprising” as used in this specification and claims means “consisting at least in part of”; that is to say when interpreting statements in this specification and claims which include “comprising”, the features prefaced by this term in each statement all need to be present but other features can also be present. Related terms such as “comprise” and “comprised” are to be interpreted in similar manner.

The platelets have a high surface area which is also accessible. The platelets are generally not planar and have a complex curved morphology similar to a rose petal. They are X-ray amorphous and have no long range order. However, NMR studies show that the immediate short range Si environment is similar to that of wollastonite, in some products of the invention.

A nano-structure is one which normally has one dimension less than 100 nm. By a nano-structure in accordance with the invention, platelets are present, which are of about 5-10 nm thickness and a plate surface width of about 50 to 500 nm. The majority of the plates will normally have a width within the range of 50 to 200 nm but higher plate widths of up to 500 mm can be observed in some of the nano-structures that have been produced in accordance with the invention. Some of these plates with higher plate widths may form a continuous wall for two or more adjacent pores. The measurement of the platelet width and thickness sizes can be from an electromicrograph of the material of the invention.

These platelets are stacked in a poorly-ordered open framework type structure to yield particles. Individual particles can vary in size. The size is dependent on a number of factors as discussed in detail below such as the extent of mechanical force exerted during the preparation of the particles. The different effects can be caused by different milling, degree of high shear mixing, sonication and the like. Usually small particles are formed having a particle size within the range of 1 to 6 microns. These smaller particles then agglomerate to form larger agglomerates. The size of these larger agglomerates is not critical to the invention but in many applications a narrow range of particle sizes is preferred. A size of 15-20 microns is generally convenient in the preparation process. But larger sizes can be produced if that is required for a specific function. Particle sizes as referred to throughout the specification and claims are the mean particle diameter size (d₅₀) as measured by a laser particle size analyzer on a dilute slurry sample. Particle size distribution can be indicated by comparing the (d₉₀), (d₅₀) and (d₅₀) values where 90%, 50% and 10% respectively of the particles have a smaller diameter than the maximum value. In many applications of the nano-structured material of the invention a narrow particle size distribution is preferred. Generally this will mean that the d₉₀ and d₁₀ values are less than 4 times and greater than a quarter respectively than that at d₅₀. For example the product of Example 6 has a (d₁₀) of 2 microns, a (d₅₀) of 5.4 microns and a d₉₀ of 19.2 microns. A broader particle size distribution is still within the scope of the invention.

The platelets are stacked in such a way as to create the pores of the invention giving a high pore volume and the high surface area, in the nano-structured calcium silicate material which are accessible. By accessibility, is meant that the openings of the pores are quite large in relation to the volume of the interior of the pore. In preferred forms of the invention the diameter of the pore opening approximates to the width of the platelets (for example as shown in FIG. 1). A range of various agents and compounds can readily enter and be accommodated within the pores and/or on the surface of the platelets defining the pore. This contrasts with a material that may have a similar pore volume but a much narrower pore opening, somewhat like a bottle, or a zeolite type material that has both a much smaller pore volume and pore opening. Such smaller pores and pores with a narrower opening are accessible only to small molecules. The larger volume and the wider opening of the pores in the material of this invention mean these pores are accessible to a wide range of other agents and compounds, particularly bulky ones. The surfaces of the platelets defining the pores are also readily accessible and can bind such other agents or compounds.

The open framework structure of the invention is readily distinguishable from other crystalline calcium silicate materials such as found in concrete. Concrete is an interlocking mass of acicular crystals evolved from small microfibrils. The nano-structure of the current invention is substantially free of any microfibrils particularly those that might be formed from calcium silicate.

The invention also provides a nano-structured calcium silicate material as defined above where the calcium ions are partially replaced by hydrogen ions by acid washing the calcium silicate material at a pH above about 6. Up to 99% (by weight) of the calcium ions can be replaced. Complete replacement is not within the scope of the invention.

The invention also provides a nano-structured calcium silicate material as defined above where the calcium is partially replaced by other metal ions such as Mg²⁺, Al³⁺ and Fe^{2+/3+} in the structure. The presence of such ions do not materially change the nano-structure framework and pore structure of the material and are not expected to cause significant changes to the properties of the material. The amount of such ions that can be incorporated will depend on whether there are material changes to the properties of the material. This can readily be determined by experimentation.

The invention further provides such nano-structured silicate materials as defined above which are hydrated wherein the water molecules are hydrogen bonded to the Ca²⁺ ions at coordination sites on the Ca²⁺ ions that are not associated with bonding to the surface silanol (—Si—OH) groups on the platelet surfaces. Water molecules can also hydrogen bond directly to such surface silanol groups not associated with the Ca²⁺ ions.

The invention further provides a silicate material as defined above in which the oil absorption is greater than 300 g. oil.100 g⁻¹ silicate.

The invention further provides a silicate material as defined above in which the oil absorption is greater than 350 g.oil.100 g⁻¹ silicate.

The invention further provides a silicate material as defined above in which the oil absorption is greater than 400 g.oil.100 g.⁻¹ silicate.

The invention further provides a silicate material as defined above in which the oil absorption is greater than 500 g. oil.100 g.⁻¹ silicate.

The invention further provides a silicate material as defined above in which the oil absorption is less than 700 g. oil.100 g.⁻¹ silicate.

The invention further provides a silicate material as defined above in which the oil absorption is less than 600 g. oil.100 g.⁻¹ silicate.

Measurement of the surface area of the novel materials of the invention, as the nano-structure develops, generally shows an increase along with an increase in the oil absorption capacity. Normally obtaining a product having an oil absorption capacity of above 300 g.oil.100 g⁻¹ silicate will produce a material having a surface area above 250 m².g⁻¹. Surface areas up to 600 m².g⁻¹ can be achieved in the novel materials of the invention.

The invention therefore further provides a nano-structured calcium silicate having an oil absorption capacity of above 300 g.oil.100 g⁻¹ silicate and a surface area of above 250 m².g⁻¹.

The invention further provides a nano-structured calcium silicate material having an oil absorption capacity from 300 to 700, preferably 350 to 600 g.oil.100 g⁻.silicate, and a surface area of from 250 to 600, such as from 260 to 600 m².g⁻¹, or from 300 to 600 m².g⁻¹.

The invention further provides a silicate material as defined above in which water is replaced by a spacer compound.

The invention further provides a silicate material as defined above in which the spacer compound has hydrogen-bonding capacity.

The invention further provides a silicate material as defined above in which the spacer compound has a higher boiling point than water.

The invention further provides a silicate material as defined above, in which the nano-structure has been reinforced by addition of further silica or silicate to the structure.

The invention further provides a silicate material as defined above, in which at least one entity selected from cations, anions and neutral molecules are accommodated in the pores or on the surface of the platelets or both in the pore and on the surface of the platelets in the nano-structure.

The invention also provides a novel nano-structured silicate material prepared by reacting a calcium ion containing solution or slurry with a silicate containing solution in a defined pH range, allowing the calcium silicate to precipitate and ageing that product to increase the order of the nano-structure, oil absorption and surface area characteristics, optionally influencing the particle and agglomerate sizes by the intensity of mixing, optionally acid washing the material, optionally reinforcing the material, optionally replacing any water within the structure with a spacer compound, optionally drying and optionally milling the material, and optionally accommodating one or more cations, anions or neutral molecules in the pores or on the surface of the platelets, or optionally any combination of two or more of those optional steps.

The invention further provides in the process of preparation the following optional conditions:
i. where the pH of the calcium and silicate solutions/slurries are matched;
ii. where the Ca⁺⁺ is added in an excess molar amount (preferably 5-10%) in comparison to the SiO₂ present;
iii. where the addition of the calcium to the silicate solution is rapid;
iv. where the rapid addition is accompanied by vigorous stirring or mixing, including high shear (high intensity) stirring or mixing and sonication;
v. where the ageing process happens with additional gentle stirring, medium or high shear (high intensity) stirring;
vi. where the ageing process happens on standing;
vii. where water is removed by drying;
viii. where water is substituted by a spacer compound;
ix. where that spacer compound is 2-ethoxyethanol (2-EE) or 2-methoxyethanol (2-ME);
x. where the spacer compound is added by plug washing of the filter cake;
xi. where the calcium silicate precipitate (usually in slurry form) is strengthened by addition of further silicate material;
xii. where the strengthening or reinforcing is through adding a sodium silicate solution.
xiii. where the pH of the calcium silicate precipitate and/or the sodium silicate solution is adjusted to enhance the strengthening of the precipitate.
xiv. where the strengthening or reinforcing is carried out with gentle stirring, medium or high shear stirring to control the size of agglomerates of the individual particles;
xv. where functionalising species are added at various stages during the process, notable to the starting solutions/slurries; prior to, during or after the ageing process; during filtration or washing; or to the dried material as detailed below.

The invention further provides that the silicate material of the invention in all the various forms is then functionalised;
a. By incorporating phase change material for heat storage and release applications.
b. By incorporating iodine, sulfur; metals and their cations for example copper, zinc, silver; and organic molecules for example omacide and hexanal; metal and metal oxide nanoparticles; and oxidizing species such as peimanganate ions for anti-microbial and biocidal applications.
c. By incorporating metal oxy-anions for example vanadate ions; chromate ions and metal ions for example zinc, copper for anti-corrosion applications;
d. By incorporating essential oils, perfumes, aroma and odouriferous compounds including foul-smelling compounds, for the controlled release of such aromas and odours.
e. By incorporating species to change the iso-electric point of the particles.
f. By incorporating species which enhance the receptivity of the pores or the surface of the plates to other entities, notably anions, cations or neutral molecules of mixtures or formulations of them therein.
g. By incorporating species to change the normally hydrophilic nature of the surface to a hydrophobic nature using for example butanol, octanol or calcium stearate.
h. By incorporating photoactive centres for example titanium dioxide for photoactive and photochemical applications.
i. By incorporating cations for example copper, anions for example phosphate or neutral molecules for example iodine for the transport and/or slow release of these species.
j. By incorporating cations for example copper, zinc, strontium, caesium and anions for example phosphate, arsenate, chromate, permanganate, rhenate by their recovery or scavenging from solutions or waters containing these species, and optionally subsequently separating these species from the calcium silicate material.
k. By incorporating conducting polymers for example polyaniline, polypyrrole and polythiophene, and their various derivatives to provide oxidation-reduction properties, electronic conductivity, opto-electronic properties, anti-corrosive and anti-microbial properties.
l. By incorporation of ionic conducting materials for solid electrolyte applications.
m. By incorporating metal or metal oxide nanoparticles.
n. By incorporating magnetic centres or metals or metal oxides.
o. By incorporating metal or metal ion centres for example rhodium for catalytic purposes.
p. By encapsulating or binding the calcium silicate material or its various functionalised forms into larger particles or pellets to better contain the functionalising species or the species being accommodated in the pores. It is noted that this functionalising species includes water.

The invention also provides a calcium or other silicate material produced by one or more of the methods of the invention. The processes of the invention produce novel silicate materials having high oil (liquid) absorption capacity and surface area and consisting of nano-sized platelets.

### BRIEF REFERENCE TO THE DRAWINGS

The invention will be described with reference to the attached drawings in which:

FIG. 1 shows electronmicroscope photographs of a nano-structured calcium silicate of the invention, depicting the open framework of nano-size platelets that provide the accessible large pore volume and accessible large surface area.

FIG. 2 is a graph showing the variation on the oil absorption and hence the development of the nano-structure of a calcium silicate of the invention in relation to concentration of dissolved silica. The base case (dilution factor =1) is a dissolved silica concentration of 35,000 mg. kg⁻¹SiO₂.

FIG. 3 shows the effect of varying the mole fraction of calcium ions and hydroxyl ions on the oil absorption properties of the calcium silicate of the invention, which has been plug washed with 2-ethoxyethanol. The mole fraction of [SiO₂]=1.

FIG. 4 shows the effect of the mole ratio of Ca:SiO₂ on the oil absorption and surface area of 2-ethoxyethanol washed nano-structured calcium silicate.

FIG. 5 is a series of electronmicroscope images showing the development of the nano-structure of a calcium silicate of the invention during ageing. The left-hand photograph is at 10 minutes, the central photograph at 60 minutes and the right-hand photograph is at 360 minutes of ageing time.

FIG. 6 shows the effect of ageing time on the development of the oil absorption capacity and surface area of the calcium silicate material of the invention.

FIG. 7 shows the effect of stirring and vessel size on the oil absorption capacity of the calcium silicate material of the invention.

FIG. 8 shows the effect of washing of the calcium silicate of the invention with 2-ethoxyethanol on oil absorption capacity and surface area, in 50 ml plug flow and at other volumes.

FIG. 9 shows the effect of the amount of silicate added in the process of reinforcing the nano-structure of the calcium silicate material with monomeric silica upon the oil absorption capacity and surface area.

FIG. 10 shows the concentration of residual monomeric silica, after 15 minutes, in the calcium silicate slurry after reinforcement by different amounts of added monomeric silica for different levels of added SiO₂ per 50 ml of aged calcium silicate slurry at 4.3 weight % solids, followed by 4 ml of 2M HCl.

FIG. 11 shows the effect of the amount of 2M HCl added during the reinforcement process on the oil absorption capacity of the resulting reinforced nano-structured calcium silicate material for the four different levels of added SiO₂ (g) per 50 ml of aged calcium silicate slurry at 4.3 weight % solids.

FIG. 12 shows effect of time on the reinforcement reaction and the oil absorption capacity and surface area of the reinforced calcium silicate material.

FIG. 13 shows the performance of a nano-structured calcium silicate of this invention as a filler in newsprint, comparing Opacity and Print Through vs Filler Loading of calcium silica of the invention, calcined clay, ground calcium carbonate (GCC) and Sipernat 820A—a product of Degussa AG.

FIG. 14 shows the uptake and release of water vapour of a nano-structured calcium silicate of this invention, cycled between relative humidity environments of 92% RH and 51% RH respectively.

### DETAILED DESCRIPTION OF THE INVENTION

The novel nano-structured silicate material generally comprises particles of between about 1-6 microns in size and larger agglomerates of these individual particles that vary in size up to about 20 microns or more. Each particle itself comprises nano-size platelets about 5-10 nm thick and generally up about 50-500 nm wide stacked together in a poorly ordered open framework type structure, forming what may be termed a silicate sponge. This somewhat resembles the petals of an open rose flower—hence is termed a “desert rose” type structure. This bestows onto the material the desirable properties of a high accessible pore volume and liquid absorption capacity and a high accessible surface area. The surfaces of the platelets can be functionalized by adsorbing or bonding a variety of cations, anions and neutral molecules which provide materials with further novel or improved properties that can be utilized in a range of applications.

The extent of openness of the framework structure and hence the magnitude of the pore volume and surface area and propensity for functionalisation can be controlled at least to some extent in the preparation of the material, particularly to reduce collapsing or partial collapsing of the structure to where the platelets stack in a more parallel type arrangement (somewhat resembling a closed rose flower).

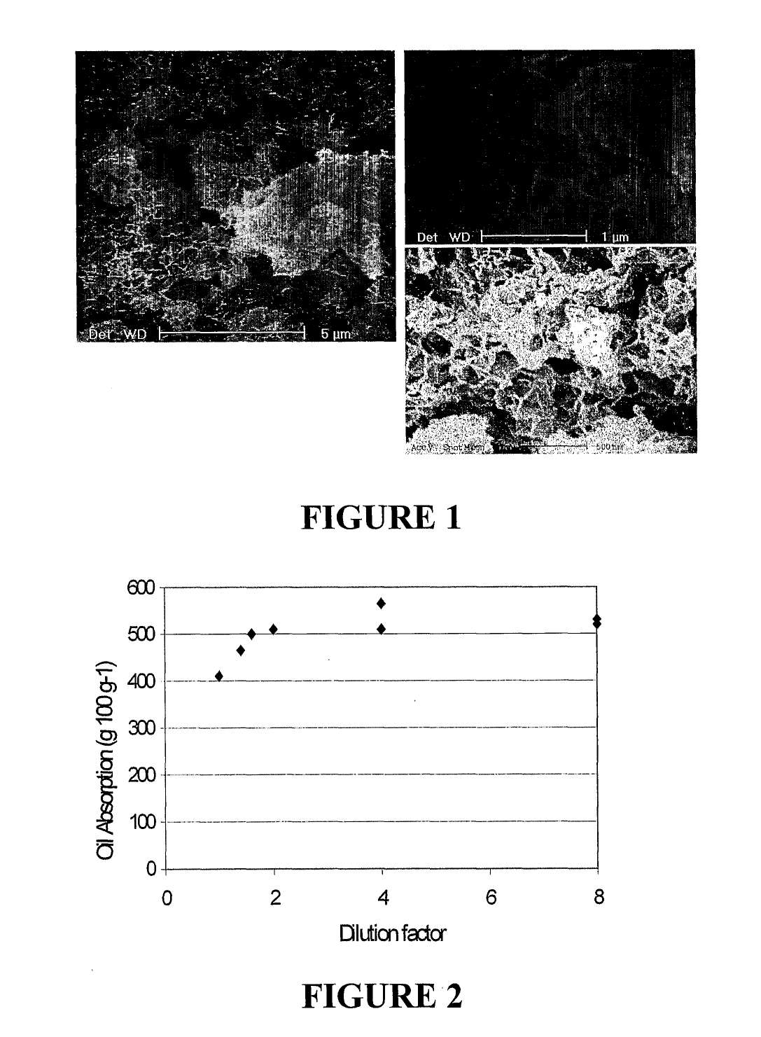

The typical structure and morphology of the open framework “desert rose” structure showing particles and agglomerates of these individual particles, with each particle itself comprising nano-size platelets is shown in FIG. 1. The particles sizes are generally greater than 1 micron and do not usually exceed about 6 micron. Larger agglomerates will generally be greater than 15 and less than about 20 microns but larger agglomerates can be achieved. The agglomerates can be broken down if desired by physical means such as high shear mixing or milling or sonication. Both the smaller particles and the larger agglomerates are discernible in the first micrograph (FIG. 1).

The thickness and width of each platelet is measurable from the micrographs shown in FIG. 1, particularly in the second and third micrographs. The thickness is normally within the 5-10 nm ranges. The width of each plate is mostly within the range of 50 to 200 nm. Wider materials than 200 nm up to 500 nm do exist tending to form a wall for two or more adjacent pores.

The nano-structured calcium silicate material and its various functionalised forms have applications in at least the following areas:
As a material with a high liquid absorbency for use in the absorption of liquids.
As an inert carrier for liquids or vapours.
As a slow release agent for liquids and vapours.
Paper filling and paper coating to improve print, optical and physical properties of the paper and paper products including paper board, and also to reduce ink demand
As an agent to improve brightness and whiteness.

In paper packaging to improve liquid and vapour absorbency and provide a controlled environment.

In paper and plastics to enhance physical properties, particularly bulking with minimal loss of other physical properties, and also as an anti-microbial agent.
In heat storage and release applications by incorporating relatively high levels of phase change energy storage and release materials.
As a material for gas adsorption in humidity control and in the control of fruit ripening.
As a material with a high surface area for use in catalysis, photoactivity and photochemistry, and a surface for chemical reactions.
As a lightweight heat insulating or ceramic material.
The (selective) adsorption, absorption or uptake of metal ions, anions and neutral species from liquids, solutions or gases.
As a material to which magnetic properties have been imparted for the (selective) adsorption, absorption or uptake of metal ions, anions and neutral species from liquids, solutions or gases.
Anti-corrosive and anti-microbial applications, particularly in surface coatings, pharmaceutical and nutraceutical applications and functional packaging.
As a substrate material for conducting polymers, nanoparticles, and other compounds with special electronic, electrochemical, magnetic and physical properties.
In catalysis wherein the metal or metal ion catalytic centre is contained in the calcium silicate material.
As a fire retardant, particularly when the pores contain water.

The preparation of this novel nano-structured calcium silicate material involves the direct addition of calcium ions to a solution of dissolved silica, usually sodium silicate, which is present mainly as H₃SiO₄⁻ silicate ions and H₂SiO₄² ions, and possibly other species such as H₄SiO₄, under controlled conditions of pH, mixing, temperature, ageing and post treatment as detailed below. The calcium ions and hydroxyl ions may be added as a solution or slurry of calcium hydroxide for which the pH may be adjusted with acid prior to addition.

Alternatively, the sodium silicate solution can be added to the solution containing calcium ions and hydroxyl ions or slurry of calcium hydroxide for which the pH has been adjusted.

Also, the respective solutions or slurries can be mixed together continuously by pumping into a common receiving or mixing vessel at controlled rates to ensure the required stoichiometry is maintained on an instantaneous and continuous basis. The resulting calcium silicate in the form of a slurry can then flow continuously into a subsequent ageing vessel.

Effective mixing must be maintained to ensure a uniform reaction between the reacting species to form a calcium silicate precipitate which can be aged to develop the required framework structure of nano-size plates and the consequent high pore volume and surface area. The intensity of the mixing influences the extent of agglomeration of the calcium silicate particles wherein the use of high shear mixing breaks down the agglomerates accordingly. The reaction may be summarized as:

H₃SiO₄⁻+Ca²⁺+OH⁻→CaSiOₓ(OH)_{y}+H₂O

Where: x is approximately 2-3
y is approximately 1-2

The reaction is preferably carried out at about room temperature (15-25° C.). The material is formed as a precipitate or as a slurry.

This precipitate or slurry may be subjected to post treatment such as functionalisation by the addition of appropriate anions, cations or neutral molecules, filtered, washed and dried as appropriate. Also, functionalisation can be achieved by adding appropriate anions, cations or neutral molecules to the solution of dissolved silica or sodium silicate solution.

The nano-structure of the calcium silicate material of the invention develops during a carefully controlled ageing step following the initial precipitation of the calcium silicate material. As a consequence and depending upon the actual preparation method used, the material has the desirable properties of a high accessible pore volume and liquid absorption capacity. The liquid absorption capacity can be measured by the ASTM D281-31 (1980). Spatula Rub-Out method.

The oil absorption capacity of products of this invention can be adjusted to achieve a desired level and with the preferred materials of the invention this capacity can be over 350 g.oil.100 g.⁻¹ silicate, such as over 400 g.oil.100 g.⁻¹ silicate, even over 500 g.oil.100 g.⁻¹ silicate up to as high as 600 g.oil.100 g⁻¹ silicate material. It is envisaged within this invention that even higher oil absorption capacity such as up to about 700 g. oil.100 g.⁻¹ silicate material can be achieved if so desired. There will invariably be a balance between the higher absorption capabilities and the consequent additional costs.

Surface areas of the nano-structured products of the invention of over 250 m².g⁻¹, such as over 260 m².g ¹, even over 300 m².g¹ and even up to about 600 m².g⁻¹ can be obtained.

In addition, the surfaces of the nano-size platelets which initially contain mainly silanol groups and bound calcium ions which may be hydrated, enable the material to be functionalized by adsorbing or bonding a variety of cations, anions and neutral molecules onto these platelet surfaces. The extent of openness of the framework structure and hence the magnitude of the pore volume and surface area and propensity for or extent of functionalisation can be controlled to some extent in the preparation process. The pore volume and surface area can be reduced in the preparation process, particularly on drying, wherein a collapsed or partially collapsed type structure where the platelets stack in a more parallel type arrangement (somewhat resembling a closed rose flower) is formed.

Accordingly, the oil absorption capacity can be reduced to about 100 g.oil.100 g⁻¹ material, and the surface area reduced to about 100 m².g⁻¹. In the drying process, the act of removing the occluded or pore water which is hydrogen bonded to the surface silanol groups, tends to pull the platelets together thereby partially collapsing the structure and reducing the pore volume and accessible surface area.

It is within the scope of the invention for the collapsed form of the nano-structured calcium silicate to be utilized in view of its oil absorption characteristics. For example in paper filling and coating techniques, it can improve print and optical properties of the paper. The collapsed material can be regenerated to a certain extent by re-slurrying in water and stirring but normally it is not possible to return the collapsed material to the absorption capacity of the original material.

In many applications of the nano-structured calcium silicate material both in the slurry form or dry state, it is desirable to utilize the high accessible pore volume and high accessible surface area. This can be achieved for material in the dry state by washing spacer compounds such as 2-ethoxyethanol (2-EE) or 2-methoxyethanol (2-ME) through the filtercake to displace the occluded or pore water before drying. Oil absorption capacity of up to about 600 g.oil.100 g⁻¹ material, and a surface area of up to about 600 m².g⁻¹ can be readily achieved. When this dried material is re-wetted, some of the spacer compound is replaced by water and a partial collapse takes place whereupon the oil absorption and surface area are reduced.

Another method for retaining the high oil absorption and surface area of the material in both the slurry and dry states is by reinforcing the nano-size platelets in the framework structure. This can be achieved by adding a quantity of sodium silicate, or silicate-containing solution with appropriate pH adjustment to the slurry of nano-structured calcium silicate following precipitation and ageing. The dissolved silicate is recovered onto the surfaces, edges and corners of the nano-size platelets through polymerization with the surface silanol groups and reaction with the surface calcium ions, thereby strengthening the framework structure. Upon drying the pore volume and surface area are substantially retained with the dry material possessing oil absorptions up to about 500 g.oil.100 g⁻¹ material, and the surface areas of up to about 500 m².g⁻¹. The product yield is increased accordingly.

As the calcium ions bound to the surfaces of the platelets are also hydrated and act as centres for hydrogen bonding of occluded water, it has been discovered that the partial removal or removal of these calcium ions by washing the material with acid to reduce the pH of the material from its original alkaline value of about pH==10-11 to about pH=6-9, is also effective in preventing the partial collapse of the framework structure upon drying. In this way the pore volume and surface area are similarly substantially retained, with the acid washed and dried material possessing oil absorptions up to about 400 g.oil.100 g⁻¹ material, and the surface areas of up to about 400 m².g⁻¹.

In the process of acid washing, the calcium content can be progressively reduced depending upon the final pH of the acid washed material, and is less than about 1 wt % Ca²⁺ at about pH=6.

The open nature of the framework structure afforded by the stacked arrangement of nano-size platelets, the accessible pore volume and large accessible surface area provides a large surface for functionalising by anions, cations, neutral molecules and conducting polymers, for specific chemical reactions to take place, for the absorption/adsorption and desorption of particular liquid and gaseous species, and for accommodating such entities as magnetic centres and nano-particles

The typical brightness of the resulting nano-structured calcium silicates as measured on the CIE scale gives values of L* of about 96-98.5; TAPPI Brightness of about 90-95; and ISO Brightness of about 90-97.

### Preparation

The preparation of nano-structured calcium silicate with different accessible pore volumes and surface areas, and in its various functionalised forms comprises the following steps:

### 1. Preparation of a Solution Containing Dissolved Silica.

This is generally in the form of the H₃SiO₄⁻ silicate ions, but possibly also with H₂SiO₄²⁻ silicate ions and silicic acid H₄SiO₄ present. This includes sodium silicate solutions and geothermal water and other naturally occurring waters containing dissolved silica.

Where sodium silicate is used as the source of dissolved silica then solutions with concentrations of dissolved silica up to about 35,000 mg.kg⁻¹ SiO₂ can be readily used. This results in “thick” slurries of nano-structured calcium silicate that are still workable. Although nano-structured calcium silicate can be readily formed from sodium silicate or similar solutions with higher concentrations of dissolved silica, the increased thickness of the resulting slurry may present workability problems during or further on in the overall process. Also, the thickness and workability of the slurry is important in allowing effective mixing to ensure uniform reaction between the reacting species and to reduce or minimize agglomeration of the nano-structured calcium silicate particles. If the reactants are mixed continuously by pumping, it is necessary to use concentrations which are amenable to effective pumping.

The issue of workability is also important in the ensuing ageing process (as discussed below) wherein the nano-structure is developed. It has been found that there is a balance between the concentration of the dissolved silica content in the starting solution, which essentially determines the thickness of the slurry of precipitated nano-structured calcium silicate, and the development of a nano-structure that exhibits a high accessible pore volume (oil absorption) and high accessible surface area in the ageing process. The preferred dissolved silica concentration is about 7,000-17,000 mg.kg⁻¹ SiO₂. This provides an easily worked solution.

FIG. 2 shows the effect of the concentration of the dissolved silica solution on the development of the nano-structure during the ageing process (as discussed further below), as measured by the oil absorption on the dry nano-structured calcium silicate material treated with 2-ethoxyethanol (2-EE) to maintain the integrity of the nano-structure. The base concentration (dilution factor =1) is 35,000 mg.kg⁻ SiO₂. This shows the nano-structure and consequent pore volume and surface area are fully developed for dissolved silica concentrations of about 17,000 mg.kg⁻¹ SiO₂ (dilution factor approximately 2). With effective or high intensity stirring during the ageing process a fully developed nano-structure can be obtained at the higher dissolved silica concentrations and also in a shorter time.

Overall, the nano-structured calcium silicate can be formed over a very wide range of concentrations from above 35,000 mg.kg⁻¹ SiO₂ to less than about 100 mg.kg⁻¹ SiO₂. For geothermal water the concentration of dissolved silica is typically up to about 1.000 mg.kg⁻¹ SiO₂.

It is preferable that this solution is prepared and maintained at room temperature (approximately 15-25° C.) to minimize energy costs. However it is recognized that temperatures up to 100° C. (or higher if the system is pressurized), can be used.

2. Combining a Source of Ca²⁺ Ions with a Silica Solution:

(a) At an Appropriate Ratio of Ca to SiO₂

On a stoichiometric basis for a CaSiO₃ type material, the Ca:SiO₂ mole ratio should ideally be 1:1. However, FIG. 4 shows that a nano-structured calcium silicate material with an oil absorption of about 500 g.oil.100 g⁻¹ material can be prepared using a mole ratio of Ca:SiO₂ ranging from about 0.9-1.3. FIG. 4 also shows that a mole ratio of Ca²⁺ to dissolved SiO₂ in solution which gives a slight excess of Ca²⁺ over dissolved SiO₂ is preferred, typically about 5-10% excess of Ca²⁺, as this ensures the rapid and complete precipitation of the calcium silicate and the effective development of the nano-structure and consequent high oil absorption and surface area. For example, this means that for a dissolved silica solution containing about 35,000 mg.kg⁻¹ SiO₂, the amount of dissolved Ca²⁺ added is about 25,000 mg.kg⁻¹ Ca²⁺, and for a dissolved silica solution containing about 8,700 mg.kg⁻¹ SiO₂, the amount of dissolved Ca²⁺ added is about 6,250 mg.kg⁻¹ Ca²⁺.

(b) At an Appropriate pH

The pH at which the combination of the Ca²⁺ solution with the solution of dissolved silica is made, is important. The pH of the Ca²⁺ solution should be approximately equal to that of the dissolved silica solution. For a dissolved silica solution prepared from sodium silicate and containing about 35,000 mg.kg⁻¹ SiO₂, the pH is about pH=11.5-11.7. When the Ca²⁺ is present in the form of a solution of calcium chloride, the pH should be increased to approximately that of the sodium silicate solution by the addition of a base, such as sodium hydroxide to the Ca²⁺ containing solution before combination with the dissolved silica solution. A convenient way for both Ca²⁺ and OH⁻ ions to be present is to utilize Ca(OH)₂. However, since the solubility of Ca(OH)₂ in water at about 1200 g.kg⁻¹ at room temperature is significantly less than that generally required, the Ca(OH)₂ is added as a slurry in water. Also, as the alkalinity of the Ca(OH)₂ slurry is generally greater than that of the dissolved silica solution prepared from sodium silicate, it is necessary to add acid to the slurry to reduce the pH to the required level before combining this slurry with the dissolved silica solution. The acid that can be used may depend on the ultimate purpose to which the silicate material is to be put. Normally hydrochloric acid is used but in some applications such as anti-corrosion, the chloride ions can be problematic. Generally nitric and acetic acids can be readily used in this and most other applications. Sulfuric acid does have limitations as this can cause the simultaneous and undesirable precipitation of calcium sulfate. It is also preferable that the Ca²⁺ solution or slurry is prepared and maintained at room temperature (approximately 15-25° C.) to minimize energy costs. However it is recognized that temperatures up to 100° C. (or higher if the system is pressurized), can be used.

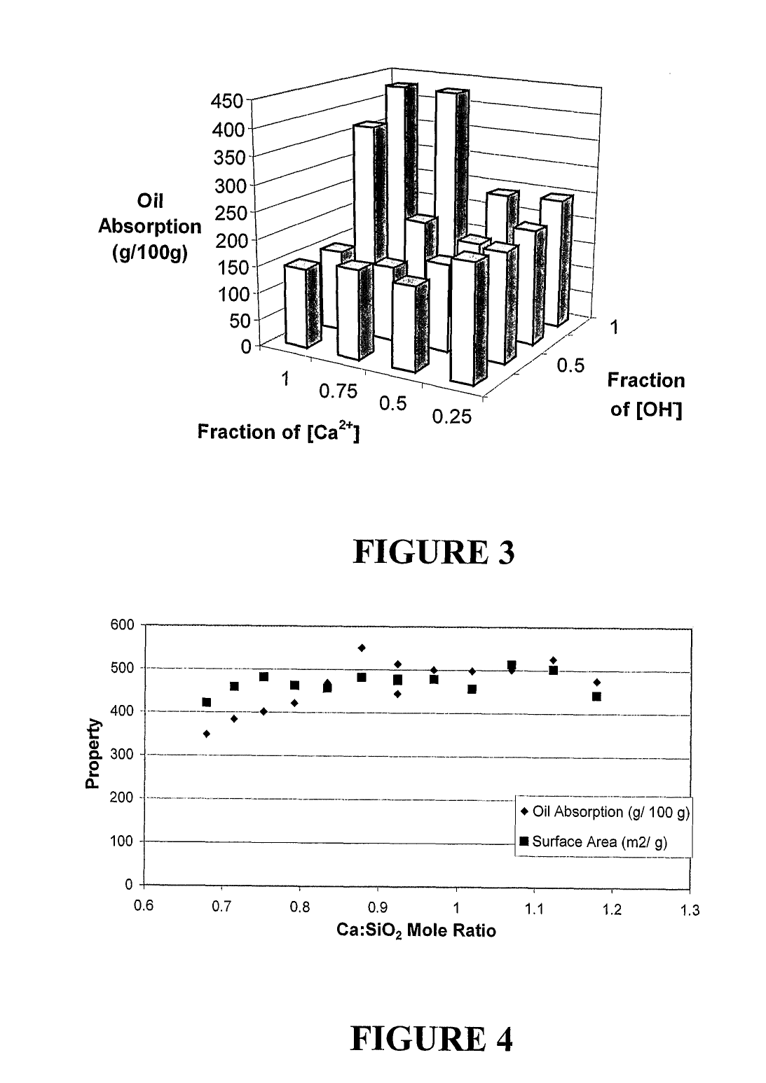

FIG. 3 shows the effect of changing the concentration of Ca²⁺ and OH⁻ ions on the development of the nano-structure as measured by the oil absorption. The concentration of Ca²⁺ and OH⁻ ions are expressed as mole fractions relative to the mole fraction of SiO₂ (normalized to 1) in the nano-structured calcium silicate material. For nano-structured calcium silicates which have been washed with 2-ethoxyethanol to maintain the integrity of the nano-structure upon drying, the nano-structure and hence the oil absorption capacity is fully developed when the mole fractions of the Ca²⁺ and OH⁻ ions are close to or preferably equal to that of SiO₂ (normalized to 1) ie [Ca²⁺]=[OH^{-]=}1.

(c) Desirably Rapidly and with Mixing

The Ca²⁺ solution or slurry is desirably rapidly combined with the solution of dissolved silica with effective mixing (stirring) wherein the nano-structured calcium silicate in its initial form is precipitated rapidly. Alternatively, the solution of dissolved silica is rapidly added to the Ca²⁺ solution or slurry with effective mixing (stirring). Also, the solution of dissolved silica and the Ca²⁺ solution or slurry can be mixed continuously by pumping into a common receiving or mixing vessel at controlled rates to ensure the required stoichiometry is maintained on an instantaneous basis. The resulting calcium silicate precipitate in the form of a slurry can then flow continuously into a subsequent ageing vessel.

When the Ca²⁺, in the form of a slurry of Ca(OH)₂ at the required pH, is used, the undissolved Ca(OH)₂ rapidly dissolves to replace the already dissolved Ca²⁺ ions that have reacted with the dissolved silica species, mainly H₃SiO₄⁻, in the silica solution.

Stirring (mixing) is very important in this combination step. Effective stirring, preferably high shear stirring or mixing must be maintained during the addition process and for a period of up to about 5 minutes thereafter to ensure uniformity and completeness of the precipitation process. This ensures a uniform reaction between the reacting species to form a calcium silicate precipitate which can be aged to develop the required framework structure of nano-size plates and the consequent high pore volume and surface area. The intensity of the mixing influences the extent of agglomeration of the calcium silicate particles wherein the use of high intensity or shear mixing breaks down the agglomerates accordingly. If agglomeration is to be minimized, high intensity or shear mixing is necessary.

During the mixing and precipitation process, the pH of the nano-structured calcium silicate slurry increases to a pH of about 12.0-12.5, typically 12.3 due to the production of OH⁻ ions in the precipitation reaction. With subsequent ageing wherein the OH⁻ ions are incorporated in the nano-structured calcium silicate material, the pH reduces to about pH=10.5-11.5, typically 11.5.

Some sources of calcium hydroxide can contain insoluble impurities for example calcium oxide and calcium carbonate, the careful addition of the calcium hydroxide slurry by decantation to the silica solution allows these impurities to be left behind in the vessel containing the slurry. Therefore the addition of a calcium hydroxide slurry to the silica solution as detailed above is the preferred method for impure calcium hydroxide materials, but the invention is not limited to this order.

This process is preferably carried out at room temperature to minimize energy costs and effective ease of addition and mixing.

### 3. Ageing of the Slurry.

The initially formed nano-structured calcium silicate precipitate is rapidly stirred for a further period of about 5 minutes to ensure compete mixing and reaction of the components, and minimal agglomeration of the calcium silicate particles. Following this the initially formed nano-structured calcium silicate is aged by effective stirring of the slurry to ensure continued mixing during which time the framework nano-structure of the calcium silicate material is progressively developed, while at the same time ensuring minimal agglomeration of the nano-structured calcium silicate particles. As a consequence the oil absorption and surface area progressively increase with time. This provides a method for preparing nano-structured calcium silicate materials with particular oil absorption capacities and surface areas by stopping the ageing process at a defined time

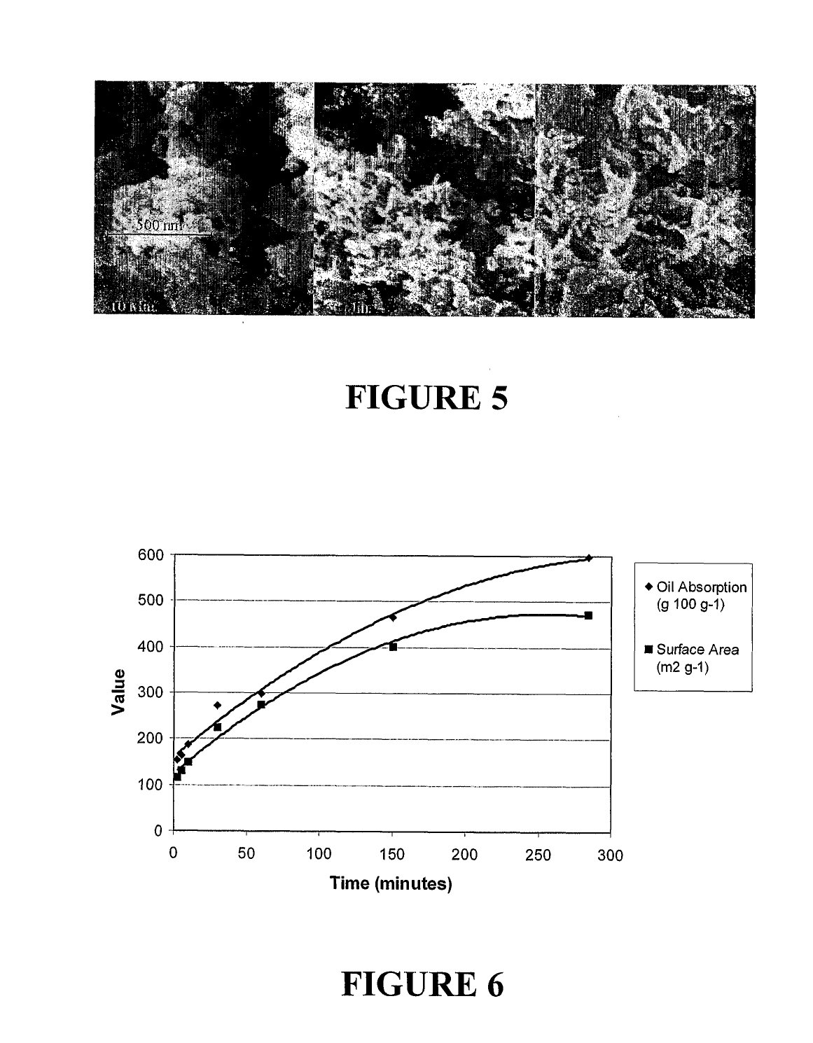

FIG. 5 shows a sequence of electronmicroscope photos detailing the development of the nano-structure of the calcium silicate at ageing times of 10 minutes, 60 minutes and 360 minutes from the addition of the source of Ca²⁺ at the required pH to the dissolved silica solution. After 10 minutes only a poorly developed nano-structure is observable which progressively develops over the ageing period. After 360 minutes ageing the nano-structure is approaching that shown in FIG. 1 for a fully aged nano-structured calcium silicate material.

The progressive development of oil absorption capacity with ageing time, and hence the progressive development of the nano-structure, is shown in FIG. 6. FIG. 6 also shows that there is a direct correlation between an increase in the oil absorption capacity and an increase in the surface area. This correlation has been observed to generally happen during ageing and the consequent development of the nano-structure.

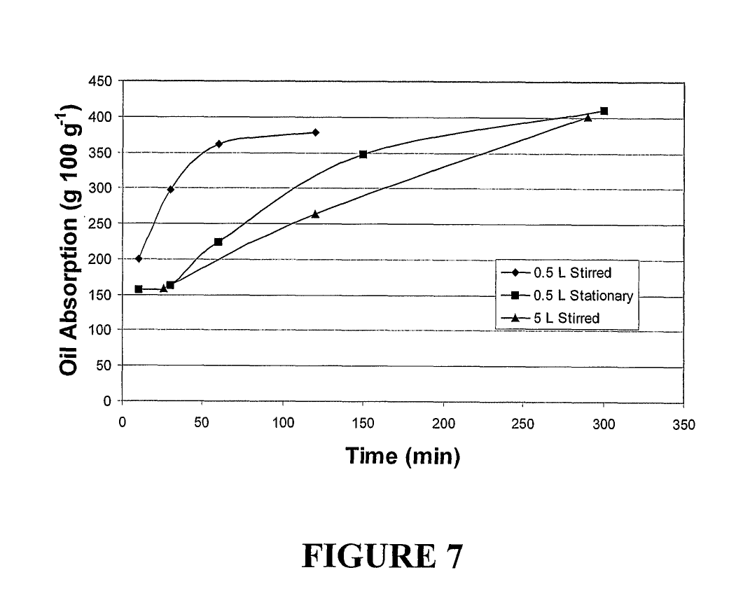

It has also been found that the actual ageing time required to develop the nano-structure varies with the effectiveness of the stirring or mixing during the ageing process. The effectiveness and intensity of the mixing is also important in ensuring minimal agglomeration of the calcium silicate particles. The mixing is governed to some extent by the vessel and stirrer design, the intensity of the stirring process and by the thickness of the slurry which is related to the initial concentration of the dissolved silica in the starting silica containing solution. For materials prepared from solutions, assuming a 5 L batch, containing about 35,000 mg.kg⁻¹ SiO₂, the ageing period is generally up to about 6 hours. For more dilute solutions the ageing period is shorter and can be as short as 1 hour. If the slurry is not stirred, the ageing process still takes place but over a longer timeframe. FIG. 7 shows the effect of stirring and vessel size (laboratory scale) on the development of the oil absorption capacity with ageing time. For a small vessel of 0.5 litres capacity with effective stirring, the nano-structure and hence the oil absorption capacity is fully developed after an ageing time of about 2 hours. If the same vessel is not stirred, the nano-structure and oil absorption capacity take about 5-6 hours to develop. If the vessel capacity is increased some 10 times, even with effective stirring the nano-structure and oil absorption capacity take about 6 hours to develop. The use of high intensity mixing reduces the ageing time significantly and is also effective in preventing agglomeration if a calcium silicate product with small and narrow particle size range is required, providing such mixing is not of an intensity high enough to disrupt the required nano-structure or adversely affect its development.

If the residual solution or dissolved ions, in that solution, do not affect the ensuing use or application of the nano-structured calcium silicate material then the aged slurry may be used directly.

### 4. Separating the Aged Precipitate:

The aged slurry is filtered and the filter cake then washed with water to remove any residual solution or dissolved ions, for example unreacted dissolved silica species, Cl⁻ from the added hydrochloric acid and Na⁺ from the sodium silicate solution, from the pores of the material and provide a filter cake of water washed nano-structured calcium silicate. Following filtration and washing the cake can then be dried to remove the water and produce a nano-structured calcium silicate material in powder form that can be optionally further ground to a finer particle size if required.

### 5. Optional Use of “Spacer” Compounds:

As detailed above, the hydrogen bonding between water contained in the pores, the silanol (Si—OH) groups and hydrated Ca²⁺ ions on the surfaces of the nano-size plates is strong enough to partially draw the plates together when the water is removed on drying, thereby partially collapsing the nano-structure and reducing the accessible pore volume and resulting oil absorption, and the accessible surface area.

The integrity of the nano-structure can be maintained by displacing the water in the pores by a liquid or solution entity (a spacer compound) which hydrogen bonds to these centres and most preferably has a higher boiling point than water. The residual water is preferentially removed by evaporation (drying) but at the same time sufficient spacer compound remains to prevent the partial collapse of the open framework structure. Typical examples of spacer compounds are 2-ethoxyethanol and 2-methoxyethanol.

Displacement of water with the spacer compound is readily achieved by plug flow washing the water washed filter cake with the spacer compound, for example 2-ethoxyethanol. In the plug flow washing process, after the filter cake is formed from the slurry, the remaining filtrate solution is removed by filtration until a thin surface layer remains. A volume of water is then added to wash the residual filtrate from the pores of the nano-structured calcium silicate filter cake until again a thin surface layer of water remains. A volume of the spacer compound, for example 2-ethoxyethanol is then washed through the filter cake displacing much of the residual water in the pores of the silicate. Filtration is continued until as much as possible of the 2-ethoxyethanol is removed. The resulting cake is then dried whereupon any residual water and the majority of the spacer compound are removed, with the hydrogen bonded residual spacer compound holding the plates apart thereby maintaining the nano-structure framework.

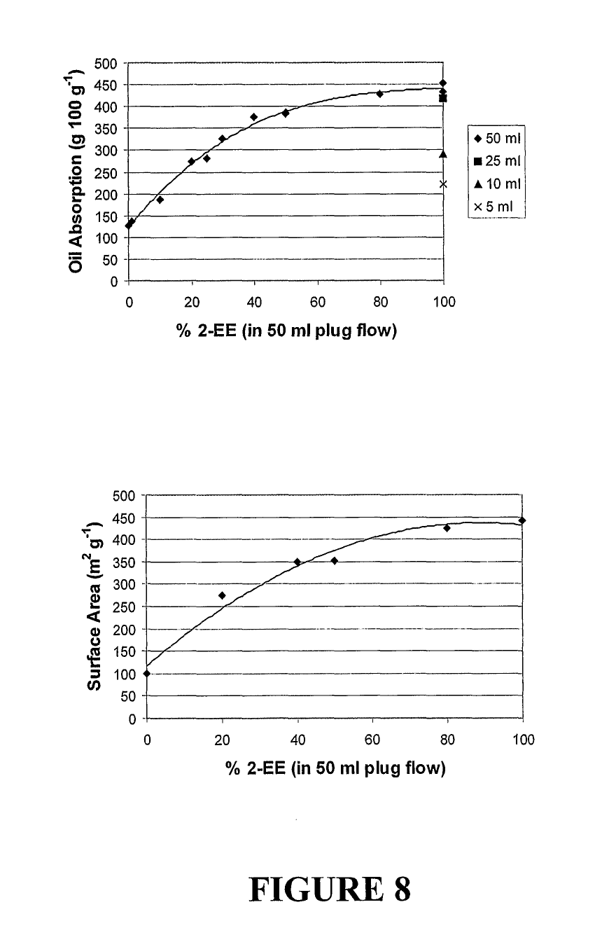

FIG. 8 shows the effect of the amount of 2-ethoxyethanol in the plug flow wash water on the development of the oil absorption capacity and surface area respectively of nano-structured calcium silicate. These data show that only a single plug flow wash of 100% ethoxyethanol can displace all the pore water and enable the full development of the nano-structure and the corresponding oil absorption capacity and surface area on drying.

### 6. The Optional Removal of Calcium Ions by Acid Washing.

While calcium is essential for the formation of the nano-structure, it also compromises the integrity of the structure during drying. As described above, unless a spacer-compound is used, the structure partially collapses upon drying leading to a material with reduced pore volume and surface area. The integrity of the nano-structure can however also be maintained to a significant extent by the removal of Ca²⁺ ions in the structure that are principally associated with the surface of the nano-size plates by washing the aged nano-structured calcium silicate slurry with acid. The Ca²⁺ ions are presumably chemically bonded directly to the plate surface on one side and to water of hydration molecules on the other side which in turn are hydrogen bonded to the water contained in the pores. As the pore water is removed by evaporation during drying, the strength of the hydrogen bonds draw the plates together thereby partially collapsing the open framework structure and reducing the oil absorption capacity and accessible surface area. The removal of the Ca²⁺ ions by acid washing which also reduces the pH of the slurry, removes the propensity for this partial collapse thereby retaining the integrity of the nano-structure on drying.

The choice of acids can be the same as those used for adjusting the pH of the calcium hydroxide slurry as in step 2 (b) above.

Table 1 shows that the oil absorption capacity is only slightly changed with a pH reduction from that of pH=12 for the initially formed slurry to about pH=10. During this process the acid is presumably protonating the silanol groups on the surface of the nano-size plates. Reducing the pH from pH=9 to pH=7 increases the oil absorption capacity significantly, to its fully achievable value. During this progressive acid treatment the calcium content is correspondingly reduced from a CaO:SiO₂ mole ratio of 0.95:1.00 for the initial nano-structured calcium silicate material to a mole ratio of 0.05:1.00 in the material that has been acid treated to yield a slurry pH of about pH=6 (Table 1). At pH values less than about pH=6, the nano-structured calcium silicate begins to dissolve and the oil absorption capacity is reduced. Spacer compounds such as 2-ethoxyethanol are not needed here to maintain the high oil absorption capacity and surface area.

Table 1 shows the effect of acid washing on the oil absorption capacity, surface area and the composition of the resulting nano-structured calcium silicate and the resulting mole ratios of CaO:SiO) (normalized to 1): LOI is the loss on ignition of the sample and essentially represents the hydroxyl and water content.

TABLE 1
Oil absorption, surface area and composition of the nano-structured
calcium silicate acid washed to particular pH values.

| | | Oil | Surface | Molar Ratios | | |
|---|---|---|---|---|---|---|
| | | Absorption | Area | | | LOI = |
| Sample | pH | (g · 100 g⁻¹) | (m² · g⁻¹) | CaO | SiO₂ | H₂O, OH⁻ |
| AJM5-82A | 12 | 113 | 60 | 0.95 | 1.00 | 1.36 |
| AJM5-82C | 10 | 148 | 111 | 0.81 | 1.00 | 1.12 |
| AJM5-82D | 8.5 | 294 | 260 | 0.55 | 1.00 | 0.96 |
| AJM5-82E | 7 | 367 | 267 | 0.11 | 1.00 | 0.38 |
| AJM5-82F | 6 | 372 | 317 | 0.05 | 1.00 | 0.28 |

The nano-structured calcium silicate material with a pH of about pH=7-9 can readily be used in paper filling or other applications where a higher alkalinity is not desired.

### 6. The Optional Reinforcement of the Calcium Silicate Nano-Structure.

The integrity of the nano-structure can also be maintained to a substantial extent and partial collapse prevented on drying from the water washed slurry by reinforcing the nano-size plates and interplate contacts. This is achieved by depositing additional silica, (presumably as calcium silicate) onto the plate surfaces and interplate contact areas. For this, additional H₃SiO₄ silicate ions, preferably from a sodium silicate solution, are added with effective and gentle stirring to the aged nano-structured calcium silicate slurry, whilst maintaining the pH at an appropriate value by the addition of acid This pH adjustment is necessary if the alkalinity of sodium silicate solution added for the reinforcement increases the pH of the calcium silicate slurry to a level where the polymerisation of the added silicate ions onto the surface of the calcium silicate plates is compromised.

In the reinforcement process, it is envisaged that the H₃SiO₄⁻ ions react with the Ca²⁺ and silanol groups on the surface of the plates thereby depositing further calcium silicate and a silica/silicate polymer directly onto these plates and their interplate contacts thereby reinforcing the nano-structure to the desirable extent where it does not collapse upon drying the water washed cake.
The reinforcement process can be carried out in either the batch process or the continuous process where the reinforcing components are added to the slurry of aged nano-structured material.

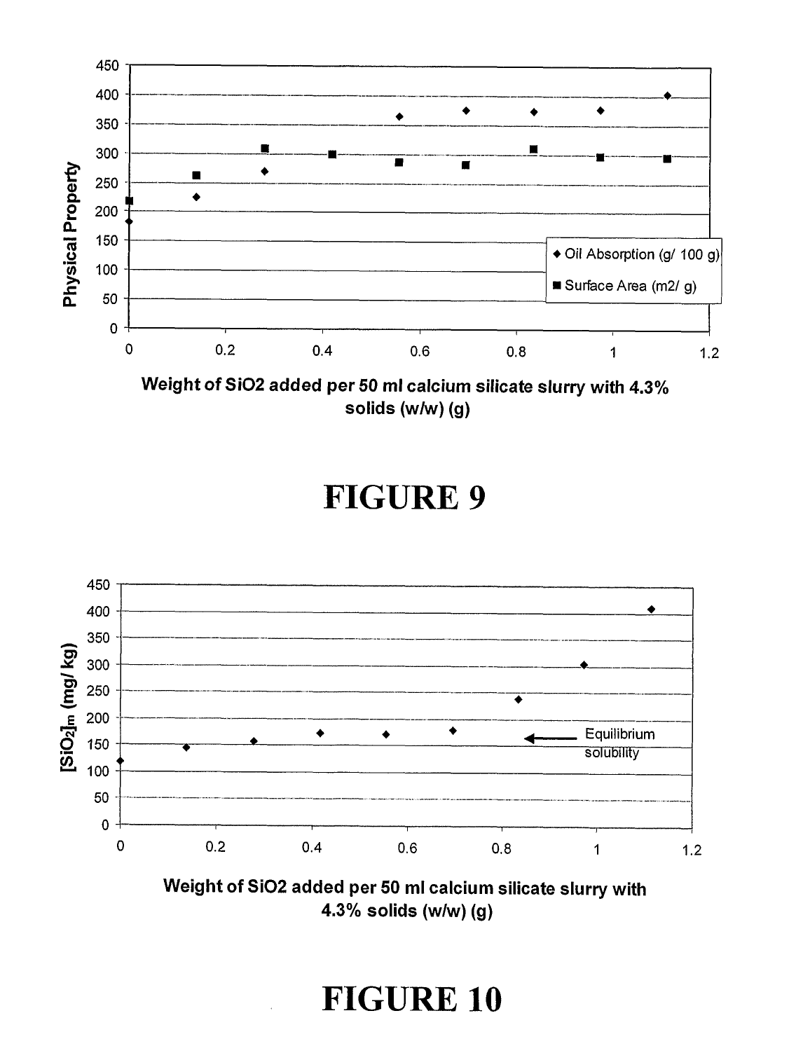

FIG. 9 shows the effect of reinforcing the calcium silicate nano-structure with different amounts (weight) of monomeric H₃SiO₄⁻ ions (expressed as SiO₂) for an aged nano-structured calcium silicate slurry on the corresponding oil absorptions and surface areas of the water washed and dried filter cake. The monomeric SiO₂ is typically added as a sodium silicate solution. With progressive reinforcement by the addition of more monomeric silica, the oil absorption capacity increases steadily up to about 380-400 g.oil.100 g⁻¹ material, and the surface area increases steadily up to a value of about 300 m².g⁻¹ in the example shown in FIG. 9.

FIG. 9 shows that there is a maximum amount of added monomeric silica above which little improvement in oil absorption capacity is achieved of about 0.6-0.7 g SiO₂ per 50 ml of aged calcium silicate slurry at 4.3 weight % solids, or about 28-33 g SiO₂ per 100 g (100%) calcium silicate. Larger quantities of added monomeric silica up to about 1.1 g SiO₂ per 50 ml of aged calcium silicate slurry at 4.3 weight % solids, show little improvement in oil absorption capacity or surface area.

FIG. 10 similarly shows that in the reinforcing process, for added monomeric silica up to about 0.7 g SiO₂ per 50 ml of aged calcium silicate slurry at 4.3 weight % solids, the residual level of dissolved (monomeric) SiO₂ in the calcium silicate slurry that is being reinforced is approximately constant at about 175 mg.kg⁻¹ SiO₂ which represents the equilibrium solubility of monomeric SiO₂ at these particular conditions. Hence, up to this level of about 0.7 g SiO₂ per 50 ml of aged calcium silicate slurry at 4.3 weight % solids, the added monomeric SiO₂ is recovered onto the platelets of the nano-structured calcium silicate thereby reinforcing the structure. At higher levels of added monomeric SiO₂, the amount of residual dissolved SiO₂ in solution increases showing that such excess levels of monomeric SiO₂ are not recovered onto the nano-structure and that the maximum extent of reinforcement has been achieved. Hence the optimum level of added monomeric SiO₂ for effective reinforcement of the structure is preferably about 33 g SiO₂ per 100 g (100%) calcium silicate. This reinforces the nano-structure to the desirable extent where it does not collapse upon drying the water washed cake.

Spacer compounds such as 2-ethoxyethanol are not required to maintain the high oil absorption capacity and surface area, but they can be used if desired.

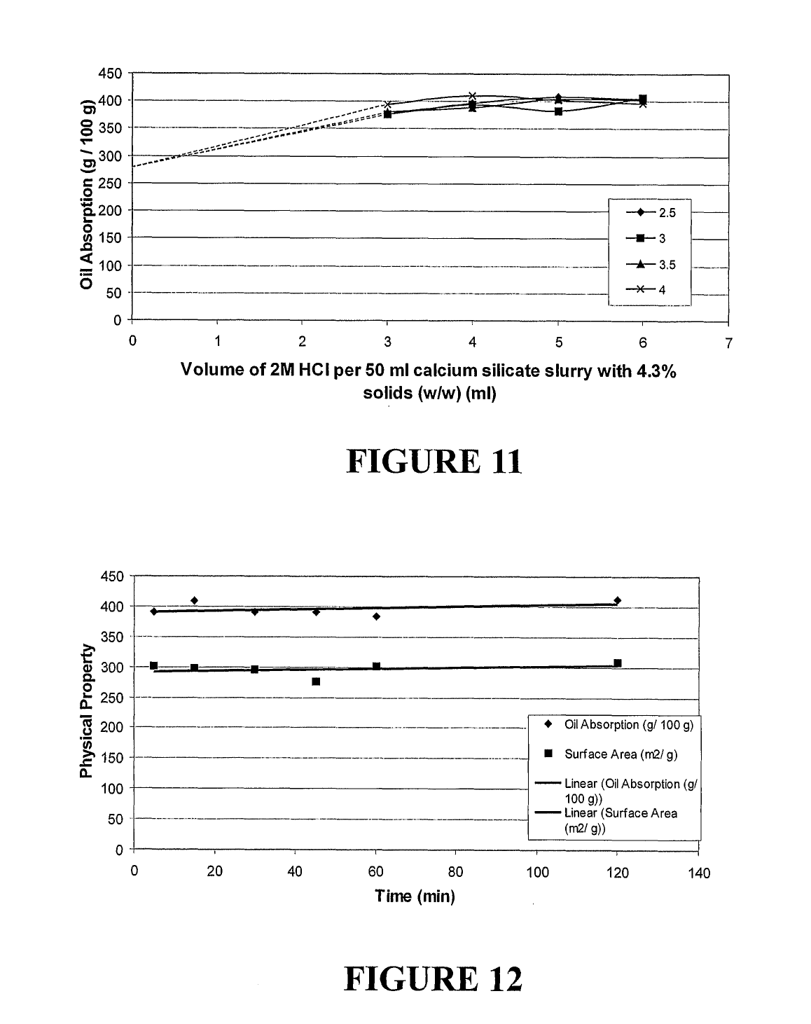

During the reinforcement process it is important to maintain the pH of the calcium silicate slurry being reinforced at a pH of about 10. Since the pH of the calcium silicate slurry and the sodium silicate solution being added for reinforcement are usually greater than pH=10, it is necessary to add acid, typically hydrochloric acid, to reduce the pH and facilitate the hydrolysis and recovery of the monomeric SiO₂ onto the surface of the platelets of the nano-structured calcium silicate. FIG. 11 shows the effect of the amount of 2 M HCl added during the reinforcement process on the oil absorption capacity of the resulting reinforced nano-structured calcium silicate material for the four different levels of added SiO₂ (g) per 50 ml of aged calcium silicate slurry at 4.3 weight % solids. This shows that a minimum level of about 3 ml of 2M HCl is required to effectively facilitate the reinforcement process under these conditions. This amount of acid can be adjusted accordingly for other concentrations and conditions. The data in FIG. 11 show the system is remarkably resilient to the amount of added acid as long as the minimum amount required to achieve and maintain the desired pH of about pH=10 is added.

Higher concentrations of acid can used, up to full strength HCl (approx 12M) wherein the quantities added are adjusted accordingly.

It has been found that the sequence of addition of monomeric SiO₂ (sodium silicate) solution and the hydrochloric acid is important in the reinforcement process. Hence it is preferable that the sodium silicate solution is added to the aged calcium silicate slurry with effective mixing first, and then followed by the addition of hydrochloric acid with effective mixing. If the acid is added to the sodium silicate solution unwanted independent polymerization of the dissolved SiO₂ takes place. The reinforcement process takes place rapidly and that for the optimum amount of added monomeric silica desired and under optimum pH conditions the high oil absorption capacity and surface area are developed within about the first 5 minutes of reinforcement reaction time and maintain a constant value thereafter (FIG. 12).

During the reinforcement process effective stirring should be maintained to ensure uniform mixing of the added monomeric SiO₂ (sodium silicate) solution and the added acid to the nano-structure calcium silicate slurry. The intensity of stirring also influences the extent of agglomeration of the reinforced particles and hence the overall particle size distribution. In order to minimize agglomeration and yield the smallest particle size and narrow particle distribution it is necessary to employ high shear mixing either immediately prior to, during or immediately following the reinforcement reaction or any combination of these stages in the process.

With the use of high shear mixing during the initial mixing of the dissolved silica solution and the Ca²⁺ solution or slurry and also in the reinforcement stage, average particle sizes of the nano-structured calcium silicate material of up to about 3-6 microns can be achieved. With lesser intense mixing the average particle size may be up to about 15-20 microns or even larger, is obtained.

### 7. The Optional Coating of the Nano-Structured Calcium Silicate by Conducting Polymers To Form Novel Nano-Structured Calcium Silicate-Conducting Polymer Composite Materials.

It is possible to coat or encapsulate the surface of the nano-structured calcium silicate by conducting polymers, preferably polyaniline, polypyrrole, polythiophene and their various derivatives. This is achieved by immersing the nano-structured calcium silicate in a solution or suspension of the polymer in water or a suitable organic liquid. Examples of this are polymethoxyaniline sulfonate in water, a dispersion of polypyrrole or polyaniline in water stabilized by a suitable dispersant, or in an organic liquid such as acetone.

The conducting polymer coating can also be achieved by the insitu polymerisation of the monomer onto the nano-structured calcium silicate. For this, the aniline, pyrrole or thiophene monomer, or their derivative forms may be applied to the nano-stluctured calcium silicate, followed by an oxidant for example ferric chloride, ammonium persulfate, hydrogen peroxide or iodine which causes polymerisation of the conducting polymer onto the surfaces of the nano-structured calcium silicate material. Alternatively, the oxidant may be added first followed by addition of the monomer. Some oxidants require aid of a catalyst as their oxidation potential is not high enough to facilitate oxidation directly. For example the oxidative strength of iodine is not high enough to generate polyaniline composites. But in the presence of calcium in the calcium silicate, iodine is activated due to forming charge transfer complexes with the calcium and thereby gains the necessary oxidation potential to facilitate polyaniline polymerisation.

UV-visible spectroscopy and thermogravimetric analysis of conducting polymer-calcium silicate composites with various calcium contents (prepared by acid washing the calcium silicate to a particular pH level), suggest that the polymers bind to the calcium and therefore that the amount of polymer incorporated into the composite is directly dependent on the calcium content of the initial silicate used. An overview of molar calcium ratios and polymer content in weight percent, % (w/w), for polymethoxyaniline sulfonate, PMAS, a derivative of polyaniline, is presented in Table 2. However other polymers prefer other binding sites than calcium, typically silanol groups, and are not affected by a change of pH to the same extent as PMAS.

TABLE 2
Mole ratios of calcium and silicate and
PMAS content at various pH levels.

| | |
|---|---|
| Mole Ratios | PMAS content, |

| pH | CaO | SiO₂ | (% w/w) |
|---|---|---|---|
| 12 | 0.95 | 1.00 | 7.5 |
| 8.5 | 0.55 | 1.00 | 2.5 |
| 7 | 0.11 | 1.00 | 0.5 |

Interestingly, oil absorption capacity and surface area measurements of the novel nano-structured calcium silicate-conducting polymer composite materials show these to be similar values to those for the precursor nano-structured calcium silicate. This suggests the formation of a novel composite material in which the available specific surface area (surface area per unit weight) of the conducting polymer can be increased significantly over that of a conducting polymer film on a planar substrate (for example glass) or other materials.

Polyaniline coated nano-structured calcium silicate materials are substantially resistant to strong acids. Normally acid below a pH of about pH=6 would dissolve the nano-structured silicate. The observation that a polyaniline coated calcium silicate does not dissolve or incur any weight loss upon treatment with strong acid confirms the integrity and completeness of the polymer coating. Composite nano-structured calcium silicate-polymethoxyaniline sulfonate materials prepared in this way have oil absorption capacities up to about 550 g.oil.100 g⁻¹ material, and surface areas of up to about 550 m².g⁻¹.

Interestingly also, measurement show that these composite materials exhibit the electronic and chemical properties inherent in the conducting polymer, notably:
The UV-Visible absorption spectra showing the electronic transitions of the conducting polymer;
Electronic conductivity which, as with conducting polymers, may be enhanced by doping with appropriate ions such as Cl⁻. This provides a new solid particulate material with electrical conductivity for use either by itself or as a composite with other materials such as plastics, paint, paper or paper packaging to impart electrical conductivity to them for applications in for example anti-static and electrical and electromagnetic shielding applications;
Oxidation-reduction properties, which may be used to recover dissolved species from solution that have a reduction potential consistent with the oxidation potential of the conducting polymer. An example of this is the recovery of silver (Ag) from a solution of silver ions (Ag⁺) directly onto the surface of the composite nano-structured calcium silicate-conducting polymer composite. These metal (silver) coated nano-structured calcium silicate-conducting polymer composites in turn are a novel material that exhibit strong anti-microbial properties. They can be used by themselves or incorporated into other material such as plastics, paint, paper and packaging, to which they impart such anti-microbial properties.
In addition, it is known previously that due to the chemical nature and oxidation-reduction potential of conducting polymers such as polypyrrole, they exhibit some inherent anti-microbial properties and anti-corrosive properties. The nano-structured calcium silicate-conducting polymer composites developed in this invention, particularly when the conducting polymer is polypyrrole, exhibit similar anti-microbial and anti-corrosive properties. Incorporation of these nano-structured calcium silicate-conducting polymer composites into other materials such as plastics, paint, other surface coatings, paper, packaging, fabrics, textiles, medical (antiseptic) dressings and healthcare products, can impart anti-microbial or anti-corrosive properties to such materials. However, the anti-microbial properties of the conducting polymer coating are not as effective as those of the silver nanoparticles on the conducting polymer-silicate surface.
Hydrophobic barrier coatings, particularly using polyaniline and polypyrrole.
   8. The optional functionalisation of the nano-structured calcium silicate by anions, Cations and Neutral Molecules.

It is possible to bond, adsorb or absorb various anions, cations and neutral molecules into or onto the surface of the nano-size plates of nano-structured calcium silicate, or in the pores. The large surface area and pore volume of the nano-structured calcium silicate material enables significant quantities of these anions, cations and neutral molecules (species) to be accommodated. Examples of these and their particular functionality are listed below.

The open framework of the nano-structured calcium silicate and its ability to offer various binding sites in the form of calcium ions and silanol groups (see earlier) enables these species to bond to some extent to the surfaces of the nano-size plates, principally through electrostatic interactions or hydrogen bonding. As such, these species are tethered into the calcium silicate nano-structure. This, together with the accessibility of the pores and surfaces means that such species can still interact with an external environment and provide specific functionality, whilst being stably accommodated in the host nano-structured calcium silicate material. In cases where the tethering is less strong, the particular species may be slowly released to the environment.

The anions, cations or neutral molecules including salts (species) may be incorporated into the pores or onto the plates of the nano-structured calcium silicate material either during the preparation stage of the nano-structured calcium silicate or after it has been formed. For incorporation during the preparation stage, which is particularly relevant to anions and cations, these species are added to or dissolved in the required amount in the initial solution containing the dissolved silica prior to addition of Ca²⁺ ions at the required pH and the consequent precipitation of the nano-structured calcium silicate. Examples of such species include Cu²⁺, Ag⁺, Zn²⁺ cations, and phosphate vanadate, molybdate, zincate anions, neutral salts and magnetic materials such as metal alloys and metal oxides like magnetite. During the formation of the nano-structured calcium silicate they are adsorbed or absorbed onto the nano-size plates, and/or accommodated in the pores.

Also, these functionalising species may be present as nanoparticles bonded to the surface. This provides a large surface area substrate and appropriately sized substrate for the nanoparticles to function. Examples are silver, gold, catalytic metals and titanium dioxide.

The incorporation of the functionalizing species after the nano-structured calcium silicate material is formed can be achieved by exposing the dry silicate material to a vapour of the species, for example iodine and sulfur; physically mixing the liquid or a suitable slurry into the dry silicate material, for example perfumes, essential oils, omacide, hexanal, phenol, chloral hydrate; or adding the nano-structured calcium silicate to a solution or suspension of the species, for example Cu²⁺, Ag⁺, Zn²⁺ cations, phosphate vanadate, permanganate, molybdate, zincate anions and iodine, chlorhexidine, omacide, chloral hydrate, and nanoparticles suspensions; or physically mixing or grinding, a solid into the silicate powder, for example sulfur and iodine, and finely divided metals.

Examples of these species and the functionality they impart to the nano-structure calcium silicate material include:
Anti-microbial, anti-fouling and antiseptic properties wherein the active component may include one or more components selected from Cu²⁺, Ag⁺, Zn²⁺, I₂, S (including polymeric S), omacide, chloral hydrate, hexanal, chlorhexidine and phenols, pennanganate, and silver nanoparticles;
Anticorrosive properties wherein the active component includes one or more compounds selected from phosphate, vanadate, molybdate, zincate, Cu²⁺, Ca²⁺, Sr²⁺, Zn²⁺ etc, Zn metal, and conducting polymers of various forms;
Strengthening agents in rubber wherein the active component is S (including polymeric S);
Metals and metal ions that function as catalysts in chemical reactions such as rhodium, palladium, gold etc.
Species that enhance the uptake and or retention of other entities, such as in environmental and coatings applications.
Photochemical and photoactive centres selected from the group including TiO₂, Ti⁴⁺ and Ti³⁺ and various rare earth elements and their ions;
Heat storage phase change materials which include alkanes, alcohols, organic acids, water, hydrated salts and mixtures thereof, salt solutions and mixtures thereof; These materials can be used for both heating and cooling applications.
Gaseous absorption or adsorption materials; with application for example in the absorption of ethylene and/or the catalytic degradation of ethylene for the control of fruit ripening, carbon dioxide for removal from air or other recovery including the recovery of ¹⁴CO₂, and hydrogen for storage purposes;
Perfumes, essential oils and aromatic compounds as air fresheners, deodorants and odour control, relating particularly to the absorption or slow release of the odouriferous material.
Species that modify the normally hydrophilic nature of the surface to that which has a hydrophobic character in order to facilitate or enhance the uptake and retention of entities that have a hydrophobic character which may also be in a hydrophilic environment. This is particularly applicable to the use of the calcium silicate material in plastics for example polyethylene and polypropylene, and also for absorbing oil from a water/oil mix or emulsion.
Encapsulating water in the pores to provide fire resistant properties.
   9. The Optional Incorporation of Phase Change Energy Storage Materials into the Nano-Structured Calcium Silicate Material.

Phase change energy storage materials (PCMs) are those that exhibit a relatively high thermodynamic heat of fusion thereby providing the opportunity to absorb and store a significant quantity of heat in the melting process and release this heat in the solidification process. A major practical problem in utilizing PCMs is the fact that one phase is a liquid and has to be contained. The nano-stiuctured silicate material described here which has a very high oil (liquid) absorption capacity is an ideal material for containing the liquid PCM. A range of novel nano-structured silicate-PCM composite materials have been produced where up to 400 wt % of PCM can be accommodated in the pores of the silicate with the nano-structured silicate-PCM composite remaining as a solid even though the PCM is present as a liquid in the pores at temperatures above the PCM melting point. This novel solid nano-structured silicate-PCM composite can in turn be mixed into paint, paper, packaging, plastic, cement, gypsum plaster, concrete, wood, ceramics etc. to provide passive heat storage and release properties to such consumer products.

Because of the open nature and accessibility of the pores, it is likely that an amount of the PCM contained in the pores can be displaced by water or other liquid medium in a particular application thereby releasing some PCM into the host material such as cement, paper, paint, gypsum plaster etc. In order to obviate or reduce this problem, the calcium silicate-PCM composite particles may be encapsulated by film or pelletised and optionally encapsulated to better retain the PCM in the calcium silicate pores.

Details of these materials and their heat storage properties are provided in the applications section below.

### 10. High Brightness and Whiteness.

Nano-structured calcium silicate as a water washed, ethoxyethanol treated or reinforced product in dry (finely) ground powder from displays excellent whiteness and brightness properties. These are typically measured by the CIE L*, a* and b* values and also by the industry standard TAPPI Brightness and ISO Brightness values (Table 3)

TABLE 3
Optical properties of nano-structured calcium silicates

| Nano-structured Calcium | | | | TAPPI | ISO |
|---|---|---|---|---|---|
| Silicate Material | L* | a* | b* | Brightness | Brightness |
| Water washed | 98.5 | 0.04 | 0.79 | 95.0 | 96.5 |
| Ethoxyethanol washed | 96.2 | −0.45 | −0.17 | 90.6 | 90.2 |
| Reinforced | 96.7 | −0.26 | −0.77 | 92.7 | 91.47 |

The data show that the water washed material is the whitest followed by the reinforced material. The use of ethoxyethanol reduces the whiteness slightly as seen by the lower TAPPI and ISO Brightness values.

The invention will now be described by way of example only with reference to the following Examples:

### EXAMPLE 1

### Preparation of Standard Concentration Nano-Structured Calcium Silicate and Water Washed and 2-Ethoxyethanol Washed Forms

Weigh 462.5 g of calcium hydroxide in a 20 litre plastic container and add 4.6 litres of distilled water. Mix well with a dispersator having a large propeller and gradually add 320 ml of 33% hydrochloric acid. Carefully wash any powder on the sides of the bucket or the dispersator shaft into the slurry with minimal water. Into a 5 litre plastic beaker weigh 1460 g of sodium silicate solution and make up to 5 litres with distilled water to give a dissolved silica concentration of 35,000 mg.kg⁻¹ SiO₂.

Increase the speed of the dispersator as much as practicable without causing splashing, and rapidly add the 5 litres of sodium silicate solution whereupon the nano-structured calcium silicate precipitates immediately. Continue stirring rapidly to ensure effective mixing and for about 5 minutes. Reduce the stirring speed so that the slurry is being gently mixed and stir for at least 4 and preferably 6 hours. The slurry can then be left to stand for about 12 hours. As it is thixotropic it will thicken on standing and will need to be gently stirred before post treatment and filtration.

Filter and plug wash the slurry with distilled water to provide a water washed material as a moist filter cake which can then be dried at 110° C. to provide a powder. The oil absorption of this nano-structured calcium silicate is about 120 g.oil.100 g⁻¹ material, and the surface area is about 120 m².g⁻¹.

To ensure the integrity of the nano-structure is maintained on drying the water washed filter cake is subjected to a plug wash of 2-ethoxyethanol which acts as a spacer compound. This provides a moist filter cake which can then be dried at 110° C. to provide a powder. The oil absorption of this nano-structured calcium silicate is about 420 g.oil.100 g⁻¹ material, and the surface area is about 400 m².g⁻¹.

### EXAMPLE 2

### Preparation of a Diluted Concentration Nano-Structured Calcium Silicate and Water Washed and 2-Ethoxyethanol Washed Forms

The procedure is the same as that for the above standard concentration nano-structured calcium silicate except that 115.5 g calcium hydroxide, 80 ml of 33% hydrochloric acid and 378 g sodium silicate are used. As the resulting sluny is more dilute after the initial rapid mixing period of 5 minutes, it is not necessary to gently mix the slurry for a further 6 hours to ensure development of the nano-structure. This development takes place effectively on standing for about 12 hours. The filter cake is typically 8-15% solids.

The oil absorption of the water washed nano-structured calcium silicate is similarly about 120 g.oil.100 g⁻¹, and the surface area is about 120 m².g⁻¹. However, the oil absorption of the 2-ethoxyethanol washed nano-structured calcium silicate is about 550 g.oil.100 g⁻¹, and the surface area is about 550 m².g⁻¹.

### EXAMPLE 3

### Preparation of Acid Washed Nano-Structured Calcium Silicate

A slurry of aged nano-structured calcium silicate is formed using the procedure detailed in either Example 1 or 2 above. The slurry is then gently and effectively stirred (this is easier for the more dilute slurry—example 2) and acid, preferably hydrochloric is added slowly to the slurry while the pH of the slurry is monitored. When the desired pH is reached which is typically pH=8-9, the slurry is left to stand or stirred for a few hours. The pH often increases by 1-2 pH units during this time and the addition of further acid is required to reduce the slurry pH to the desired value. The amount of calcium remaining in the structure at different final pH values of the acid washed slurry are given in Table 1 above. The slurry is then filtered and washed with water and optionally dried to give a nano-structured calcium silicate materials with an oil absorption of about 350 g.oil.100 g⁻, and the surface area is about 260 m².g⁻¹. The filter cake is typically 8-15% solids.

### EXAMPLE 4

### Preparation of Reinforced Nano-Structured Calcium Silicate

A slurry of aged nano-structured calcium silicate is formed using the procedure detailed in either Example 1 or 2 above. The slurry is then effectively stirred (this is easier for the more dilute slurry—example 2) and sodium silicate is added in an amount about 11 g of SiO₂ per 100 g of nano-structured calcium silicate over a few minutes and then stirring continued for about 10 minutes. The slurry is then filtered and washed with water and optionally dried to give a nano-structured calcium silicate materials with an oil absorption of about 280 g.oil.100 g⁻¹, and the surface area is about 250 m².g⁻¹. When high intensity (shear) stirring is used during or at the end of the sodium silicate addition, the agglomerates of calcium silicate are broken down to yield a product with a particle size of about 5-8 microns. With lesser intense mixing the average particle size can be up to about 15-20 microns. The filter cake is typically 8-15% solids.

### EXAMPLE 5

### Preparation of Reinforced Nano-Structured Calcium Silicate with a Higher Oil Absorption

A slurry of aged nano-structured calcium silicate is formed using the procedure detailed in either Example 1 or 2 above. The slurry is effectively stirred (this is easier for the more dilute slurry—example 2) and sodium silicate is slowly added in an amount about 28-33 g SiO₂ per 100 g (100%) calcium silicate of nano-structured calcium silicate. Dilute HCl is then added with effective stirring to the slurry to ensure precipitation and polymerisation of the added silicate ions onto the calcium silicate plates in an amount equivalent to 3 ml of 2 M HCl per 50 ml of aged calcium silicate slurry at 4.3 weight % solids. The pH of the resulting reinforced nano-structured calcium silicate slurry is about pH=10. When high intensity (shear) stirring is used during or at the end of the sodium silicate addition, the agglomerates of calcium silicate are broken down to yield a product with a particle size of about 3-6 microns. With lesser intense mixing the average particle size can be up to about 15-20 microns.

The slurry is then optionally filtered and washed with water and optionally dried to give a nano-structured calcium silicate material with an oil absorption of about 380-400 g.oil.100 g⁻¹, and the surface area is about 300 m².g⁻¹. The filter cake is typically 8-15% solids.

### EXAMPLE 6

### Preparation of Reinforced Nano-Structured Calcium Silicate with a Higher Oil Absorption Using a Continuous Process on a 1 Litre Scale

To 459 ml of water 29.8 g (25.8 ml) of 31% HCl was added. While stirring the solution, 34.7 g of calcium hydroxide was added (to give a 500 ml slurry).

A 500 ml sodium silicate solution was made by adding 88.2 g of sodium silicate (containing 29.2% SiO2) to 437 ml of water.

These two solutions were then pumped at the same rate using a dual-headed peristaltic pump into the base of a small reaction vessel that was stirred vigorously whereupon they combine to form nano-structured calcium silicate as a slurry. After a short residence time this slurry overflows continuously into a large storage vessel with gentle stirring. This slurry was effectively stirred for about three hours to yield an aged nano-structured calcium silicate product, before proceeding with the reinforcement step as per below. The intensity of stirring during mixing of these two streams is important in preventing agglomeration and in determining the particle size of the resulting nano-structured calcium silicate material. With high intensity mixing particles sizes of about 3-6 microns can be achieved. With lesser intensity mixing the particle can be up to about 15-20 microns reflecting the formation of larger agglomerates.

A further sodium silicate solution was made up by adding 63 g of sodium silicate to 350 ml of water. This solution was added to the aged nano-structured calcium silicate slurry while it was being stirred over a period of up to a few minutes. Finally the pH of the slurry was lowered by adding a hydrochloric acid solution prepared by adding 23.5 g of 31% HCl to 80 ml of water over a period of up to a few minutes to ensure effective precipitation and polymerisation of the added silicate onto the surface of the nano-structured calcium silicate plates to reinforce the structure accordingly. When high intensity or shear stirring is maintained during or implemented after the reinforcement stage particles sizes of about 3-6 microns can be achieved. Again, with lesser intensity mixing larger agglomerates of about 10 microns, or even up to 15-20 microns can form.

After the slurry had been allowed to mix for 5 minutes it is then optionally filtered and washed with two plug flows of water and optionally dried and milled. Alternatively, the slurry can be used directly. The filter cake is typically 8-15% solids.

The resulting nano-structured calcium silicate product has an oil absorption of about 380-400 g.oil.100 g⁻¹; a surface area of about 300 m².g⁻¹; a L* Brightness of about 96, a TAPPI Brightness of about 93 and an ISO Brightness of about 92; and a particle size distribution with a d₁₀ of 2 microns, a d₅₀ of 5.4 microns and a d₉₀ of 19.2 microns.

### EXAMPLE 7

### Preparation of Heat Energy Absorption, Storage and Release Materials

Heat energy absorption, storage and release material can be prepared by incorporating a phase change material (PCM), typically alkanes or hydrated salts into the pores of the nano-structured calcium silicate material.

In particular, various amounts of the Rubitheim RT25 alkane (paraffin) phase change material (PCM) which melts at about 25° C., was mixed into a nano-structured calcium silicate in the dry powder form in which the nano-structure was maintained by the 2-ethyoxyethanol spacer compound, to levels of 100 wt %, 200 wt %, 300 wt % and 400 wt % RT25 with respect to the silicate. In all cases the composite energy absorption, storage and release material remained as a free flowing powder. The heat energy absorption and release capacities were measured by differential scanning calorimetry (DSC) and the composite nano-structured calcium silicate—400 wt % RT25 material shown to have a heat energy absorption and release capacity of about 110 J.g⁻.

This composite nano-structured calcium silicate—400 wt % RT25 material was then added to cement in various quantities up to 50 wt %; to paint in various quantities up to 40 wt %, plaster of paris (gypsum plaster such as that used in wall board) in various quantities up to 50 wt %, and to paper as a filler in various quantities up to 20 wt %. DSC measurements were conducted for a number of these composite materials which indeed demonstrate that such novel materials do exhibit significant heat energy absorption, storage and release capacities. The cement containing 50 wt % of the nano-structured calcium silicate—400 wt % Rubitherm RT25 composite showed a heat storage capacity of about 33 J.g⁻¹; the paint containing 40 wt % of the nano-structured calcium silicate—400 wt % of Rubitherm RT25 composite showed a heat storage capacity of about 45 J.g⁻¹; and plaster of paris (gypsum plaster) containing 50 wt % of the nano-structured calcium silicate—400 wt % of Rubitherm RT25 composite showed a heat storage capacity of about 45 J.g⁻¹.

Similar composite materials using nano-structured calcium silicate and Rubitherm RT20 (melting point about 20° C.) were prepared, and added to paint, gypsum plaster and cement in both similar and larger quantities. The heat storage capacities were comparable to those of the Rubitherm RT25 composites.

Similar nano-structured calcium silicate-PCM composites have been formed with RT20 (melting point about 22° C.), RT2 (melting point about 6° C.) and RT6 (melting point about 8° C.) and their heat storage and release properties measured similarly.

By using PCMs that have melting points at or above ambient temperature the nano-structured calcium silicate-PCM composites can be used in heating applications and moderating the temperature in environments at or above that of the ambient temperature. This is particularly useful in heat storage applications.

Conversely, by using PCMs that have melting points below ambient temperature the nano-structured calcium silicate-PCM composites can be used in cooling applications and moderating the temperature in environments below that of the ambient temperature. This is particularly useful in cool storage environments and the packaging, transport and storage of perishable goods, particularly food, wherein it is important to buffer the effects of temperature changes.

Because the nano-structured calcium silicate contains hydroxyl groups and usually some occluded water, it can be heated by microwave radiation. Hence a composite nano-structured calcium silicate-PCM material can be readily heated to above the PCM melting temperature by placing the composite in a microwave oven. The effectiveness of the heating can be enhanced by accommodating both water and PCM in the pores of the nano-structured calcium silicate material. This is considered to be a significant feature of the nano-structured calcium silicate material and opens up opportunities for the development of new products and applications of the nano-structured calcium silicate-PCM material that utilize indirect heating of such as heat treatment packs for thermal massage, food warming etc.

Also, because of the open nature and accessibility of the pores, it is likely that an amount of the PCM contained in the pores can be displaced by water or other liquid medium in a particular application thereby releasing some PCM into the host material such as cement, paper, paint, gypsum plaster etc. This can be obviated or reduced by encapsulating the calcium silicate-PCM composite particles in a polymer film, by precipitating additional silica/silicate on the surface of the composite particles, or by pelletising the calcium silicate-PCM composite particles.

### EXAMPLE 8

### Preparation of Composites of Nano-Structured Calcium Silicate with Iodine and Sulfur

Composites of nano-structured calcium silicate with iodine have been prepared by lightly mixing up to about 20 wt % 12 crystals with nano-structured calcium silicate powder, preferably 2-ethoxyethanol washed, and heating the composite up to about 100° C., preferably 60-80° C. for up to 12-24 hours preferably up to 2-5 hours in a closed environment. The 12 vaporises and diffuses into the pores of the nano-structure and is adsorbed or bonded onto the surface of the nano-size platelets. Further detailed spectroscopy studies suggest the iodine is bonded to the surface calcium ions and may be in the form of a charge transfer complex. If the Ca²⁺ ions are removed by acid washing only low, if any amounts of iodine can be incorporated stably in the nano-structure. The nano-structured calcium silicate-iodine composite material is then heated to a temperature of up to about 80-120° C. in an open environment wherein the excess or unbonded iodine is removed by vaporisation. The complete removal of the excess or unbonded iodine is most readily determined by the achieving of constant weight during the open environment heating. Heating experiments show that the iodine in the nano-structured calcium silicate-iodine composite is stably bound up to a temperature of 200° C. and with further heating up to 800° C. the iodine is progressively lost from the structure (Table 4). The content of I₂ in the calcium-silica is typically 3-15 wt %. The compositions of typical iodine calcium-silica materials are shown in Table 4.

Composites of nano-structured calcium silicate with sulfur have been prepared by mixing together, preferably by grinding or milling, nano-structured calcium silicate powder, preferably 2-ethoxyethanol washed, and elemental sulfur, with the sulfur being in an amount up to about 5 wt % S. The mix is then heated in a closed environment at a temperature up to about 200° C. whereupon the S is adsorbed or bonded onto the surface of the nano-size platelets to form a nano-structured calcium silicate-sulfur composite material. Photoelectron spectroscopy measurements suggest the sulfur is bonded to oxygen and exists in a form similar to sulfate which is presumably coordinated to the surface Ca²⁺ ions. Heating experiments show the sulfur in the nano-structured calcium silicate-sulfur composite is stably bound up to at least 800° C. (Table 2). The compositions of typical nano-structured calcium silicate-sulfur composite material are shown in Table 4.

Composites of nano-structured calcium silicate-sulfur-iodine have also been prepared by combining the above two procedures. (Table 4)

TABLE 4
Iodine and sulfur contents of composites
with nano-structured calcium silicate

| | Temperature | Iodine Content | Sulfur Content |
|---|---|---|---|
| Host Element | (° C.) | (wt %) | (wt %) |
| Iodine | 25 | 7.28 | |
| Iodine | 200 | 7.55 | |
| Iodine | 400 | 5.09 | |
| Iodine | 600 | 2.26 | |
| Iodine | 800 | 0.17 | |
| Sulfur | 25 | | 2.68 |
| Sulfur | 200 | | 3.11 |
| Sulfur | 400 | | 3.38 |
| Sulfur | 600 | | 3.39 |
| Sulfur | 800 | | 3.52 |
| Iodine + Sulfur | 25 | 5.09 | 1.77 |

### EXAMPLE 9

### Preparation of Composites of Nano-Structured Calcium Silicate with Titanium Dioxide

A dilute slurry of nano-structured calcium silicate powder in iso-propanol was prepared by adding 1 g of nano-structured calcium silicate powder that had first been exposed to 100% Relative Humidity environment to ensure water molecules were present in the pores and on the surface of the nano-size platelets, to 50 mL of iso-propanol in a 100 mL flask equipped with a magnetic stirrer. The slurry was stirred constantly while an amount of titanium isopropoxide to give a mole ratio of Ca:Ti of 1:1, was added under a blanket of nitrogen to prevent unwanted titanium dioxide formation by reaction with moisture in the air. The mixture was refluxed for about 18 hours, following which 20 mL of water was added and the slurry stirred for a further 2 hours. During this overall process, the titanium isopropoxide hydrolysed as the anatase polymotph of titanium dioxide hydrate and was incorporated into the pores and surfaces of the nano-structured calcium silicate material. This composite material was then filtered, dried and calcined at 650° C. for 18 hours whereupon sub-micron size spherical crystals of anatase were formed in and on the nano-structured calcium silicate. Alternatively hydrothermal treatment can be used to effect crystallization to the anatase form. The material was characterized by electromnicroscopy and x-ray diffraction, which confirmed the presence of microcrystals of anatase accommodated in the calcium silicate. The photoactivity was tested by the photodegradation of an organic compound phenolphthalein) in a slurry with the nano-stiuctured calcium silicate-titanium dioxide material under UV light. As a comparison, no photodegradation of phenolphthalein was observed using only nano-structured calcium silicate and UV light. This confirmed the photochemical activity of the nano-structured calcium silicate-titanium dioxide material.

### EXAMPLE 10

### Preparation of Composite Calcium Silicate—Vanadate for Anti-Corrosion Applications

A solution containing 5,000 mg.kg⁻¹ SiO₂ was prepared and to this sufficient sodium vanadate (Na₃VO₄) was added to give a concentration of 1,000 mg.kg⁻¹ Vanadate in the silicate solution. A nano-structured calcium silicate-vanadate composite was precipitated by adding 10,000 mg.kg⁻¹ Ca²⁺. The resulting slurry was filtered and washed with water. In similar examples, the use of higher concentration starting silicate solutions and Ca²⁺ slurries can be used with the amount of vanadate added to the sodium silicate solution being adjusted accordingly. In such cases the procedure is similar to that detailed in examples 1 and 2 above. However, at these higher concentrations it is necessary to effect a pH adjustment to the calcium hydroxide slurry using hydrochloric acid. As Cl⁻ ions are known to accelerate the corrosion process it is essential that they are fully washed from the resulting vanadate-silicate product. Alternatively, the pH adjustment can be made by preferably using acetic acid instead of hydrochloric acid which obviates the potential Cl⁻ ion problem.

The moist, washed filter cake was mixed directly into a latex paint formulation at levels up to 10 wt % composite in the paint. However, higher levels can be used. This paint was applied to mild steel plates along with the latex paint as a control. In addition, a similar paint was prepared using a commercially available anti-corrosion agent. A cross was scored through the paint to expose the steel surface for each sample. The painted plates were then subjected to a corrosive environment. The paint containing the nano-structured calcium silicate-vanadate material showed significant corrosion resistance compared with the control. It also showed superior performance to the paint containing the commercial anti-corrosion agent. In areas where the paint was removed by a solvent after the tests show essentially no corrosion of the underlying steel surface for the nano-structured calcium silicate-vanadate containing paint, whereas the surface of the control shows significant corrosion, and that with the commercial anticorrosion agent show corrosion intermediate between the two.

### EXAMPLE 11

### Preparation of Hydrophobic Nano-Structured Calcium Silicate

A hydrophobic nano-structured calcium silicate suitable for absorbing hydrophobic liquids, or selectively absorbing hydrophobic liquids in the presence of hydrophilic liquids in the form of suspensions or emulsions has been prepared as follows. The nano-structured calcium silicate powder was placed in a porous container and suspended in a vessel capable of holding a pressure of about 20 atmospheres. A volune of 1-butanol was placed in the vessel to a level below that of the porous container. The vessel was sealed and heated to a temperature of about 180-200° C. for about 2 hours, then cooled and opened. During heating, the 1-butanol vapourised and reacted with the silanol groups on the surface of the nano-size platelets rendering the surface hydrophobic. The resulting hydrophobic nano-structured calcium silicate powder was removed from the porous container. When sprinkled on water, the material floated demonstrating its hydrophobic nature. This material also selectively absorbed oil from an oil/water mix or emulsion.

Other alcohols with a longer hydrocarbon chain length such as octanol can also be used.

As alternative way to impart a hydrophobic surface to the nano-structured calcium silicate material is to treat the surface with a solution of calcium stearate wherein the stearate binds to the surface of the silicate.

### EXAMPLES OF APPLICATIONS

The following are examples of applications of nano-structured calcium silicate material in its various forms and various functionalised:

### Application Example 1

### Use in Paper Filling to Enhance Opacity and Reduce Print Through, and Also to Enhance Bulk Properties

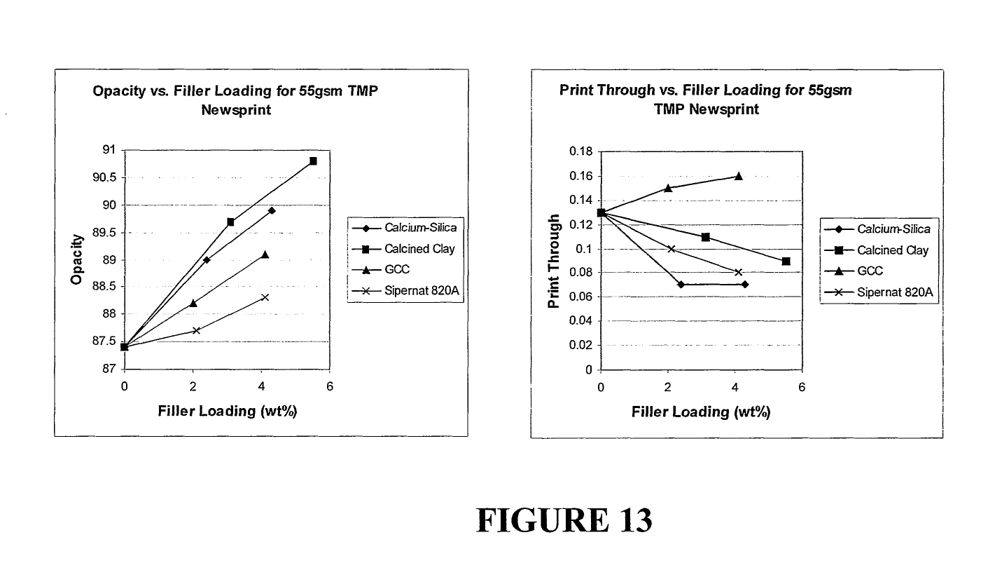

Nano-structured calcium-silicate having an oil absorption of about 350 g.oil.100 g⁻¹ has been successfully tested as a filler in 45 gsm and 55 gsm newsprint made from 100% thermomechanical pulp (TMP), with filler loadings of about 2 wt % and 4 wt %. Similar tests were carried out using calcined clay, ground calcium carbonate (GCC) (90%<2 microns) and an aluminosilicate Sipernat 820A, for comparison purposes. The optical and physical properties were measured on calendered sheets. The results for 55 gsm newsprint are shown graphically in FIG. 13.

The results (FIG. 13) show that the increase in opacity with filler loading for 45 gsm and 55 gsm TMP newsprint filled with nano-structured calcium silicate and calcined clay are similar, and significantly better than GCC or Sipernat 820. At a 2 wt % loading, calcined clay and nano-structured calcium silicate increase the opacity of 45 gsm newsprint by about 3.2 points and of 55 gsm newsprint by about 1.3 points. These increases are about twice that provided by GCC and about 3 times that provided by Sipemat 820.

The high oil absorption capacity of the nano-structured calcium silicate is particularly effective in reducing print through (the printed image showing through to the reverse side of the sheet). For both 45 gsm and 55 gsm TMP newsprint the nano-structured calcium silicate has substantially outperformed calcined clay and GCC, and is also significantly better than Sipernat 820, particularly for 55 gsm newsprint. At a 2 wt % filler loading, nano-structured calcium silicate reduces print through by about 40% for 55 gsm newsprint and by an impressive 51% for 45 gsin newsprint, the latter being quite remarkable (FIG. 13).

The nano-structured calcium silicate material claimed here is therefore an effective filler in increasing the opacity of newsprint sheet and substantially reducing print through.

In addition, physical properties of the paper sheet have shown conclusively that the bulk of the paper sheet can be increased over than of the unfilled sheet. In this application the nano-structured calcium silicate outperforms other fillers such as clay and calcium carbonate.

### Application Example 2

Use in a paper coating formulation to improve print quality, especially for ink-jet printing.

Any of the nano-structured calcium silicate products of the invention in the form of a moist filtercake has been added to a coating formulation and applied to the surface of a paper sheet. The sheet was then printed using a colour ink-jet printer. The colour definition, sharpness and clarity of print were significantly improved over that for the same image printed on uncoated paper. This material is particularly suitable to application in the size press stage of a paper making operation.

### Application Example 3

### Use as an Inert Carrier, Absorption and Also as Slow Release Agent for Liquids

(a) Essential Oils, Perfumes and Aromatics

The essential oils, pine oil and clove oil have been mixed into and absorbed in the pores of separate samples of dry nano-structured calcium silicate. These were placed in open dishes. Similar quantities of the pine oil and lavender oil were also placed in open dishes. All dishes were left in the open and the odours emanating from them monitored by smell over a period of about 1 year. During this time the aromas evolved by the pine and lavender oils in the open dishes were initially stronger than the aromas evolved by the oils contained in the nano-structured calcium silicate. However after a period of about 3 months the aromas from the pine and lavender oils in the open dishes were barely detectable as most of the active aroma compounds had largely evaporated in this time. In contrast, the oils contained in the nano-structured calcium silicate continued to evolve aromas that were readily detectable by smell. As such, it is clear that the nano-structured calcium silicate material is an effective slow release agent for essential oils and other aromatic compounds.

(b) Odoriferous Repellent Compounds

In addition, the liquid active ingredients of the animal repellants, notably crotyl mercaptan and also isoamyl mercaptan and butane thiol have been absorbed into nano-structured calcium silicate thereby making these compounds in a solid rather than liquid or paste form. Such a solid form can be easily spread around lawns, gardens etc where animals are not wanted. Also, the nano-structured calcium silicate affords the slow release of these active compounds.

(c) Deodorants and Antiperspirants

The nano-structured calcium silicate can be used as an active component in a deodorant or antiperspirant formulation. In this application it functions as an absorber of body fluids (sweat) and also as a medium for the slow release of perfume type species. When Al³⁺ is present such Al³⁺ can be slowly released to the skin and function in a manner similar to conventional Al³⁺-containing deodorants.

If the nano-structured calcium silicate is functionalised with Ag⁺ or Ag nanoparticles, then anti-microbial activity is also imparted to the deodorant or antiperspirant formulation.

### Application Example 4

### Use as a High Absorbent Material for Absorbing and Cleaning Up Liquid Spills for Example Food, Wine, Oil Etc

Any of the nano-structured calcium silicate powders of the invention have been shown to be effective in cleaning up liquid spills, for example food colourants, sauces, beverages, wine etc; oils and other liquids, from carpet and other flooring materials and fabrics. Ideally the nano-structured calcium silicate powder should be applied in excess to the liquid spill immediately after the spill occurs, whereupon the liquid is quickly absorbed into the large pore volume of the silicate. However, if the liquid spill has soaked into the substrate material, the nano-structured calcium silicate powder can be worked into the pile of the carpet or pores in the fabric etc where it is effective in absorbing the liquid that has soaked in. If excess silicate is used, the resulting silicate-liquid material remains as a powder and can then be removed by vacuum suction. Repeated applications of the nano-structured calcium silicate may be required to remove the liquid or significantly minimize its undesirable impact.

### Application Example 5

### Use as an Absorbent or Adsorbent in Recovering Metal Ions and Anions Such as Phosphate, chromate, arsenate, vanadate, molybdate, zincate, aluminate, technatate, Rhenate Etc from Solutions Containing these Dissolved Species

Nano-structured calcium silicate has shown to be effective in adsorbing metal ions and anions from solutions, particularly when they are in low concentrations of a few hundred mg.kg⁻¹ or less. The moist filter cake form of the water washed nano-structured calcium silicate may be used directly as the open framework structure and hence accessibility to the large pore volume and surface area is maintained since the material is not dried. The 2-ethyoxyethanol washed material of the reinforced material can be used in either the moist filter cake form or the dry form respectively.

For example, in the uptake of copper or zinc ions from solution, a 1 g (dry weight basis) of water washed nano-structured calcium silicate moist filter cake was added to a 1 litre solution containing 100 mg.kg⁻¹ each of dissolved silver, copper and zinc metal ions. The solution with the silicate suspension was stirred and samples of the solution taken at time intervals of 15, 30, 60 and 180 minutes from the silicate addition. These samples were analysed for their silver, copper and zinc contents. The results (table 5) show that after 15 minutes the majority of the silver, copper and zinc have been removed by the nano-structured calcium silicate. After 60 minutes the levels in solution are: silver —0.05 mg.kg⁻¹, copper-0.11 mg.kg⁻¹, and zinc—0.06 mg.kg⁻¹, which demonstrate the substantial effectiveness of nano-structured calcium silicate as an adsorbent of these metals from solution. This has important application in cleaning up industrial wastewater and mine water streams. The nano-structured calcium silicate material containing the adsorbed metal ions can be removed by filtration and dissolved in a small quantity of acid to yield concentrated solution of the metals for ensuing metal recovery and recycling by conventional methods such as electrolysis.

TABLE 5
The residual concentrations of silver, copper and zinc ions
in solution following the addition of nano-structured calcium
silicate to the solution to adsorb these ions.

| | Residual Concentration in Solution | | |
|---|---|---|---|
| Time | Silver | Copper | Zinc |
| (minutes) | (mg · kg⁻¹) | (mg · kg⁻¹) | (mg · kg⁻¹) |
| 0 | 100 | 100 | 100 |
| 15 | 1.7 | 0.12 | 0.14 |
| 30 | 0.05 | 0.11 | 0.06 |
| 60 | 0.05 | 0.06 | 0.04 |
| 180 | 0.04 | 0.05 | 0.03 |

Oxy-anions such as phosphate, arsenate, chromate etc can be removed from solution by the addition of nano-structured calcium silicate to the solution containing these species. For this, the oxy-anion reacts with the Ca²⁺ ions on the surface of the nano-structured calcium silicate platelets and forms the calcium oxy-anion salt, which usually has a very low solubility.

For example if phosphate is the anion, a precipitate or crystals of calcium phosphate in one or a number of its various forms such as apatite, hydroxyapatite etc can form on the surface of the nano-structured calcium silicate thereby removing phosphate from solution.

If the oxy-anion is in low concentrations of the order of a few mg.kg⁻¹ such as arsenate in geothermal waters, the oxy-anion is adsorbed onto the surface of the platelets and a discreet calcium oxy-anion species is not formed as the solubility product of such a species is not exceeded.

### Application Example 6

### Use as an Absorbent of Water Vapour and in Passive Humidity Control

Nano-structured calcium silicate powder, particularly the 2-ethoxyethanol form can be used to absorb and release water vapour and provide a measure of passive humidity control to the immediate environment.

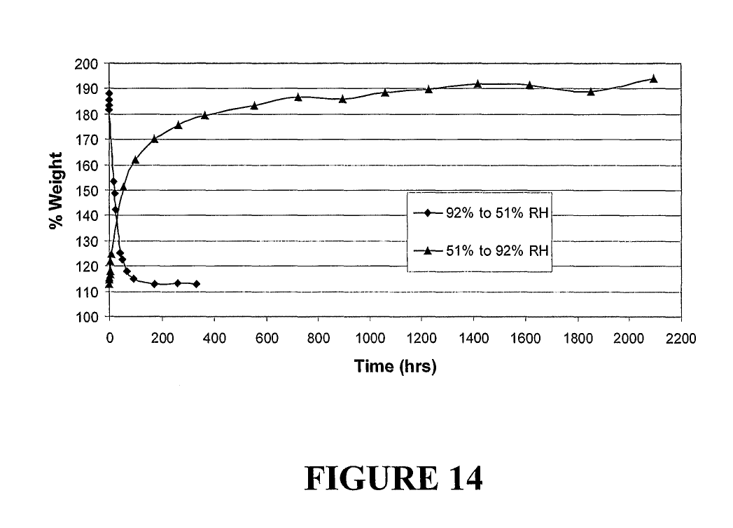

This has been demonstrated by placing a sample of dry nano-structured calcium silicate treated with 2-ethoxyethanol in a closed environment where the relative humidity was maintained at 92% RH by a saturated salt solution of potassium nitrate at room temperature. The increase in weight due to the uptake of water was monitored over an 87 day period. During this time the nano-structured calcium silicate essentially absorbed its own weight of water vapour (194% increase), (FIG. 14). The increase in weight is approximately exponential with the passage of water into the pores being diffusion controlled. There is approximately a 25% weight gain in the first 8 hours and approximately a 50% weight gain in the first 48 hours. The water laden sample was then removed from the 92% RH environment and placed in a similar closed environment where the relative humidity was maintained at 51% RH by a saturated salt solution of calcium nitrate. Again the weight change was monitored with time. The results (FIG. 14) show that approximately 25% of the water in the nano-structured calcium silicate was lost in the first 4 hours and approximately 50% was lost in the first 20 hours. These data show that the nano-structured calcium silicate responds to the relative humidity of the environment by absorbing and hence removing water vapour from a high humidity environment, and also releasing it back to a low humidity environment with a response time of several hours. Hence it is useful as a medium to provide a measure of passive humidity control.

### Application Example 7

### Use in Heat Storage and Release Applications

Examples of the preparation and use of composites of nano-structured calcium silicate with phase change materials (PCM) for heat storage and release applications are given in Preparation Example 7 above. For this, the composite nano-structured calcium silicate-PCM material with up to 400% PCM using RT25, RT20, RT6 and RT2 PCMs have been prepared and incorporated variously into paint, cement, gypsum plaster, paper and paperboard and the resulting energy uptake (storage) and release properties measured.

The composites with RT25 and RT20 provide the opportunity for the capture and release of heat at or above ambient temperature and also providing a temperature moderating effect at these temperatures. These have particular applications in the built environment and in medical/massage heat treatments of injuries.

Conversely, composites with RT2 and RT6 provide the opportunity for the capture and release of heat below ambient temperature and also providing a temperature moderating effect at these temperatures. For example, a nano-structured calcium silicate composite with RT6 has been incorporated into the flutes in fluted board packaging and also into cavities in a specially designed packaging insert. Thermal conductivity measurements and heat up and cooling rate measurements demonstrate that the nano-structured calcium silicate composite with RT6 retards the heat up and cooling rates in the region of the PCM melting point and hence acts as an effective buffering agent in such packaging applications.

### Application Example 8

### Use in the Control of Fruit Ripening and Prolonging the Shelf Life of the Fruit

Nano-structured calcium silicate can be used to absorb ethylene gas emitted from fruit during the ripening process and also the carbon dioxide emitted as a consequence of the ripening. In addition, infrared (IR) absorption studies have shown that the inherent mild photochemical or photocatalytic properties of the nano-structured calcium silicate material are effective in inducing the degradation of ethylene. This effect is more pronounced in direct sunlight.

The effectiveness of nano-structured calcium silicate in prolonging the shelf life of fruit has been successfully demonstrated as follows. For this, samples of nectarines, apricots, bananas, peaches and pears were each sealed in a plastic bag with a 1 g quantity of nano-structured calcium silicate contained in a porous sachet. Similar samples of these fruits were each sealed in plastic bags without the nano-structured calcium silicate to serve as respective controls. The plastic bags were placed in a sunlight environment and the extent of degradation of the fruit was monitored visually with time. In all cases areas of decay were observed in the control samples about 1-2 weeks before they were observed on the samples in the bags with the sachets of nano-structured calcium silicate. In all of the control samples decay was observable after about 1 to 2 days. Also, the spread of decay was much more rapid in the control samples.

Following these demonstrations, the samples of nano-structured calcium silicate were removed from the sachets and analysed. The gas evolved on heating was shown by mass spectrometry to contain ethylene confirming the ability of the nano-structured calcium silicate to absorb this gas which is emitted by ripening fruit. In addition, IR analysis of this silicate material showed the presence of carbonate peaks which presumably result from the absorption of carbon dioxide evolved by the ripening fruit reacting with the hydrated Ca²⁺ on the surface of the platelets to form calcium carbonate in the pores. The IR spectra also show degradation products of ethylene showing its photocatalytic degradation by the calcium silicate.

Nano-structured calcium silicate is therefore effective in controlling fruit ripening and extending the shelf life of the fruit.

### Application Example 9

### Use as a Material with a High Surface Area in Photocatalysis and Photoactive Applications

Examples of the preparations and use of a composite of nano-structured calcium silicate with titanium dioxide as a high surface area photochemical agent are given in Example 7 above.

### Application Example 10

### Use as a Hydrophobic Material for Selectively Absorbing Oil Floating or Suspended in Water, or from an Oil-Water Emulsion

Hydrophobic nano-structured calcium silicate prepared according to preparation method in example 11 above, was mixed into an emulsion of oil in water. The hydrophobic nano-structured calcium silicate selectively absorbed the oil and settled to the bottom of the container. Due to the large pore volume, the material can accommodate a similarly relatively large volume of oil. The resulting water, now essentially free of oil was decanted off. This demonstrates the effectiveness of hydrophobic nano-structured calcium silicate in selectively absorbing oil in the presence of water.

### Application Example 11

### Use as an Anti-Microbial Agent

Nano-structured calcium silicate composites with iodine and sulfur prepared according to preparation method in example 6 above, can be used as anti-microbial agents. Their anti-microbial activity has been demonstrated by sprinkling these materials onto half the surface of slices of bread and placing the bread in an environment conducive to the growth of mould for a period of 10 days. A slice of bread with no silicate was used as a control. The anti-microbial action of the nano-structured calcium silicate composites with iodine and sulfur was visually evident. No mould grew where these materials had been sprinkled on the bread surface. When compared with the control sample it was also visually evident that the anti-microbial effect, particularly for the nano-structured calcium silicate composite with sulfur extended beyond the area where the material was sprinkled on the bread. This demonstrates the effectiveness of the nano-structured calcium silicate composites with iodine and sulfur as anti-microbial agents.

In addition, a sample of nano-structured calcium silicate was treated with silver nitrate solution wherein Ag⁺ ions were adsorbed onto the surface of the platelets. This functionalised material and the calcium silicate by itself were placed in a petrie dish containing a agar solution. Staphylococcus aureus (ATCC 25923) bacteria were introduced into the agar and the system was incubated for 24 hours. An ensuing examination showed that the bacteria had spread through the petrie dish except in the region of the calcium silicate-Ag⁺ material which showed an inhibition zone of about 2 mm wide around the material thereby demonstrating the anti-microbial effectiveness of this functionalised material.

In a further example, silver nanoparticles were deposited on the surface of the nano-structured calcium silicate material and the anti-microbial activity of this composite was against Staphylococcus aureus was similarly characterized. This showed that the calcium silicate-silver nanoparticles composite demonstrated anti-microbial properties comparable to those of the calcium silicate-Ag⁺.

In yet a further example species such as hexanal, chlorinated organics and inorganics, and particular oxidizing agents which display anti-fungal or anti-microbial activity can also be incorporated into the calcium silicate and the resulting functionalised calcium silicate incorporated into other materials to impart such anti-microbial activity to these materials.

It is likely that these calcium silicate materials specifically functionalised to impart anti-microbial properties can be incorporated into medical dressings to provide anti-microbial activity, in paints to prevent mould growth and also to provide a sterile painted surface in the built environment.

In addition if they are incorporated into paper or plastics they can impart anti-microbial properties to the paper and plastics which may then be used to provide sterile packaging, or packaging with active preservation properties.

### Application Example 12

### Use in Pharmaceutical and Nutraceutical Applications

The high pore volume and oil absorption capacity of the nano-structured calcium silicate material has applications in pharmaceutical nutraceutical products where inert carrier and/or liquid absorption properties are required. This is introduced in example 3(c) above. In particular it can be used as an absorbent in deodorants and skin care products that absorb unwanted or odorous body oils and sweat. In addition, the near neutral pH of body skin will engender the release of calcium that can then be absorbed through the skin. The material can also be used as a bath salt to similarly absorb body liquids and provide a source of calcium. If the silicate is functionalised with Al³⁺, such Al³⁺ may be slowly released to the skin and function in a manner similar to conventional Al³⁺—containing deodorants. Also, if the silicate is functionalised with Ag⁺ or Ag nanoparticles then effective anti-microbial properties can be imparted to the deodorant or antiperspirant formulation.

The product can also be used as a carrier of body lotions and skin care preparations.

### Application Example 13

### Use as a Light Weight Ceramic

Thermal measurements have shown that the nano-structure of the calcium silicate material is stable up to a temperature of about 650-680C whereafter heating to higher temperatures causes the structure to breakdown and crystalline wollastonite is formed. This provides the opportunity to use the material as a lightweight ceramic at temperatures up to about 630C. For this, the calcium silicate can be pressed or cast into appropriate shapes. However as the material is friable, dusting can be problematic. This can be overcome by subjecting the cast nano-structured calcium silicate shape to hydrothermal treatment at about 150-200C for a few hours in the presence additional calcium hydroxide and/or sodium silicate, which binds the calcium silicate particles together into a non friable ceramic.

### Application Example 14

### Use as a High Brightness Agent

Nano-structured calcium silicate prepared in either the water washed, ethoxyethanol treated or reinforced forms demonstrate high brightness and can be used as agents to enhance whiteness and brightness. Table 3 above presents the CIE L*, a* and b* values and also by the industry standard TAPPI Brightness and ISO Brightness values that are used to measure such whiteness. For maximum brightness and whiteness where oil high absorption capacity and high surface area are not required the water washed material can be used. The reinforced material displays the best balance of brightness and whiteness, and oil absorption and surface area properties.

The material may be used as a filler or in coating formulations to impart such brightness and whiteness properties to the particular application.

While this invention has been described with reference to preferred embodiments it is not to be construed as limited thereto. Furthermore where specific materials or steps in a process have been described and known equivalents exist thereto, such equivalents are incorporated herein as if specifically set forth.

### INDUSTRIAL APPLICATION

Novel nano-structured calcium silicate materials of this invention have a wide variety of industrial uses, such as in paper filling, with phase change energy storage materials, with biologically active substances, or as an absorbent or adsorbent for gaseous substances, and many others as more particularly described herein.

1. A nano-structured calcium silicate material which comprises nano-size platelets about 5-10 nm thick and about 50-500 nm wide stacked together in a poorly-ordered open framework type structure to provide pores which are accessible and a consequent high pore volume.

2. A material as claimed in claim 1 wherein the platelets are about 50-200 nm wide.

3. A material as claimed in claim 1 wherein the material is formed from particles having a mean particle size within the range of 1 to 6 microns.

4. A material as claimed in claim 3 additionally including agglomerates of the particles.

5. A material as claimed in claim 4 wherein the agglomerates have a mean particle size of 15 to 20 microns.

6.-7. (canceled)

8. A material as claimed in claim 1 wherein the calcium is partially replaced by other metal ions such as Mg²⁺, Al³⁺ or Fe^{2+/3+} in the structure.

9. A material as claimed claim 1 wherein the oil absorption is from 300 g. oil.100 g⁻¹ silicate to 700 g.oil.100 g⁻¹ silicate.

10.-11. (canceled)

12. A material as claimed in claim 9 wherein the oil absorption is from 350 g. oil 100⁻¹ silicate to 600 g.oil.100 g.⁻¹ silicate.

13. (canceled)

14. A material as claimed claim 1 having a surface area of from 250 m.²g.⁻¹ to 600 m.²g⁻¹.

15. A material as claimed in claim 12 having a surface area of from 250 m.²g.⁻¹ to 600 m.²g⁻¹.

16. A material as claimed in claim 14 having a surface area within the range of from 300 m.²g.⁻¹ to 600 m.²g.⁻¹.

17. A material as claimed in claim 1 wherein water is replaced by a spacer compound.

18.-20. (canceled)

21. A material as claimed in claim 1, wherein the nano-structure has been reinforced by addition of further silica or silicate to the structure.

22. A material as claimed in claim 1, wherein at least one entity selected from cations, anions and neutral molecules are accommodated in the pores or on the surface of the platelets or both in the pore and on the surface of the platelets in the nano-structure.

23. A material as claimed in claim 1 which is subsequently dried to partially or substantially completely remove occluded water to collapse the open framework and reduce the oil absorption capacity.

24. A process for producing a nano-structured silicate material comprising combining a calcium ion containing aqueous solution or slurry with a silicate containing aqueous solution in a defined pH range, allowing the calcium silicate to precipitate and ageing that product to increase the order of the nano-structure, oil absorption and surface area characteristics.

25. A process as claimed in claim 24 additionally comprising influencing the particle and agglomerate sizes by the intensity of mixing.

26. (canceled)

27. A process as claimed in claim 24 additionally comprising reinforcing the material.

28. (canceled)

29. A process as claimed in claim 24 additionally comprising drying and milling the material.

30. A process as claimed in claim 24 additionally comprising accommodating one or more cations, anions or neutral molecules in the pores or on the surface of the platelets.

31. A process as claimed in claim 24 wherein the pH of the calcium and silicate solutions/slurries are matched.

32. A process as claimed in claim 31 wherein the Ca⁴⁺ is present in an excess molar amount in comparison to the SiO₂ present.

33. A process as claimed in claim 32 wherein Ca is present in 5 to 10% excess molar amount.

34. A process as claimed in claim 24 wherein the combination of the calcium containing solution with the silicate solution is rapid.

35. A process as claimed in claim 34 wherein the rapid combination is accompanied by vigorous stirring or mixing, including high shear (high intensity), optionally with sonication.

36. (canceled)

37. A process as claimed in claim 24 wherein the ageing process happens on standing or with additional gentle stirring, medium or high shear (high intensity) stirring.

38. (canceled)

39. A process as claimed in claim 24 wherein water is removed by drying.

40.-41. (canceled)

42. A process as claimed in claim 24 wherein the calcium silicate precipitate is strengthened by addition of further silicate material.

43. A process as claimed in claim 42 wherein the strengthening or reinforcing is through adding a sodium silicate solution.

44. A process as claimed in claim 43 wherein the pH of the calcium silicate precipitate is adjusted to enhance the strengthening of the precipitate.

45. A process as claimed in claim 42 wherein the pH of the sodium silicate solution is adjusted to enhance the strengthening of the precipitate.

46. A process as claimed in claim 42 wherein the strengthening or reinforcing is carried out with gentle stirring, medium or high shear stirring to control the size of agglomerates of the individual particles.

47. A process as claimed in claim 24 wherein one or more functionalising species are added at various stages during the process.

48. A process as claimed in claim 47 wherein the species are added to the starting solutions/slurries; prior to, during or after the ageing process; during filtration or washing; or to the dried material.

49.-68. (canceled)

69. A process as claimed in claim 24 wherein the material so obtained has an oil absorption capacity of at least 300 g. oil.100 g⁻¹ silicate.

70. A process as claimed in claim 24 wherein the material so obtained has an oil absorption capacity of less than 700 g. oil.100 g⁻¹ silicate.

71. A process as claimed in claim 24 wherein the material so obtained has an oil absorption capacity of from 300 to 600 g. oil.100 g⁻¹ silicate.

72. A process as claimed in claim 24 wherein the material so obtained has an oil absorption capacity of from 350 to 600 g. oil.100 g⁻¹ silicate.

73. A process as claimed in claim 24 wherein the material so obtained has a surface area of at least 250 m²g⁻¹.

74. A nano-structured calcium silicate material having an oil absorption capacity of at least 300 g.oil.100 g⁻¹ silicate and a surface area of at least 250 m.²g.⁻¹.

75. A nano-structured calcium silicate material as claimed in claim 74 having an oil absorption capacity of at least 350 g.oil.100 g⁻¹ silicate and a surface area of at least 300 m.²g.⁻¹.

76. A nano-structured calcium silicate material as claimed in claim 74 having an oil absorption capacity of from 300 g.oil.100 g⁻¹ silicate to 700.oil.100 g⁻¹ silicate and a surface area of from 250 m.²g.⁻¹ to 600 m.²g.⁻¹.

77. A nano-structured calcium silicate material as claimed in claim 74 having an oil absorption capacity of from 350 g.oil.100 g⁻¹ silicate to 600.oil.100 g⁻¹ silicate and a surface area of from 250 m.²g.⁻¹ to 600 m.²g.⁻¹.

78. A material as claimed in claim 74 wherein the material comprises nano-size platelets about 5-10 nm thick and about 50-500 nm wide stacked together in a poorly-ordered open framework type structure to provide pores which are accessible and a consequent high pore volume.

79. A material as claimed in claim 78 wherein the platelets are about 50-200 nm wide.

80. A nano-structured calcium silicate material as claimed in claim 78 wherein the material is formed from particles having a mean particle size within the range of 1 to 6 microns.

81. A nano-structured calcium silicate material as claimed in claim 80 additionally including agglomerates of the particles.

82. A material as claimed in claim 81 wherein the agglomerates have a mean particle size of 15 to 20 microns.

83. A functionalised nano-structured calcium silicate material comprising a material as claimed in claim 1 together with at least one functionalising species.

84. A functionalised nano-structured calcium silicate material as claimed in claim 83 wherein each species is selected from the group consisting of phase change materials, biologically active substances, anti-corrosion substances, odoriferous substances, species which enhance the receptivity of the pores or the surface of the plates to other entities, species which change the isoelectric point of the particles, species which convert the normally hydrophilic nature of the surface of the plates to a hydrophobic nature, photoactive substances, conducting polymers, ionic conducting materials, metal and metal oxide nanoparticles, magnetic substances and catalytic substances.

85. A functionalised nano-structured calcium silicate material as claimed in claim 83 treated to inhibit the escape of the functionalising species.

86. A functionalised nano-structured calcium silicate material as claimed in claim 83 wherein each species is selected from phase change materials.

87. A functionalised nano-structured calcium silicate material as claimed in claim 86 wherein water is included along with the phase change material to permit additional heating by microwave energy.

88. The use of a nano-structured calcium silicate material as claimed in claim 83 in an application selected from the group consisting of heat storage and heat buffering applications, anti-corrosion, paper filling, as an inert carrier to absorb and slowly release liquids, to absorb and clean up liquid spills, to recover metal ions and anions from solution containing these dissolved ions, in passive humidity control, control of fruit ripening, prolonging the shelf life of fruit, in photocatalysis and photoactive applications, with a hydrophobic surface coating to selectively absorb oil in combination with water, as an anti-fungal agent, as an anti-microbial agent, in pharmaceutical and nutraceuticals, as a high brightness agent, as a light weight ceramic, and as a fire retardant.

89. The use of a nano-structured calcium silicate material as claimed in claim 83 in paper filling.

90. A functionalised nano-structured calcium silicate material comprising a material as claimed in claim 74 together with at least one functionalising species.

91. A functionalised nano-structured calcium silicate material as claimed in claim 90 wherein each species is selected from the group consisting of phase change materials, biologically active substances, anti-corrosion substances, odoriferous substances, species which enhance the receptivity of the pores or the surface of the plates to other entities, species which change the isoelectric point of the particles, species which convert the normally hydrophilic nature of the surface of the plates to a hydrophobic nature, photoactive substances, conducting polymers, ionic conducting materials, metal and metal oxide nanoparticles, magnetic substances and catalytic substances.

92. The use of a nano-structured calcium silicate material as claimed in claim 90 in an application selected from the group consisting of heat storage and heat buffering applications, anti-corrosion, paper filling, as an inert carrier to absorb and slowly release liquids, to absorb and clean up liquid spills, to recover metal ions and anions from solution containing these dissolved ions, in passive humidity control, control of fruit ripening, prolonging the shelf life of fruit, in photocatalysis and photoactive applications, with a hydrophobic surface coating to selectively absorb oil in combination with water, as an anti-fungal agent, as an anti-microbial agent, in pharmaceutical and nutraceuticals, as a high brightness agent, as a light weight ceramic, and as a fire retardant.
